(19) United States
(12) Patent Application Publication
(10) Pub. No.: US 2026/0217525 A1
(43) Pub. Date: Jul. 30, 2026

(54) SYSTEM AND METHOD FOR PRODUCTION OF HYDROGEN

(71) Applicant: Lux Esto LLC, Royal Oak, MI (US)

(72) Inventor: Kenneth Peebles, Royal Oak, MI (US)

(21) Appl. No.: 19/459,698

(22) Filed: Jan. 26, 2026

Related U.S. Application Data
(60) Provisional application No. 63/876,342, filed on Sep. 5, 2025.
(60) Provisional application No. 63/750,513, filed on Jan. 28, 2025.

(51) Int. Cl. C01B 3/36; C01B 3/48; C25B 1/044; C25B 1/23; H01M 8/0656

(52) U.S. Cl. CPC C01B 3/36; C01B 3/48; C25B 1/044; C25B 1/23; H01M 8/0656; C01B 2203/0255; C01B 2203/0283; C01B 2203/061; C01B 2203/062; C01B 2203/068; C01B 2203/1241

(57) ABSTRACT

A system and method for producing low-cost, low to zero-carbon, and emission-free hydrogen (H₂) is provided. The system includes an auto-thermal reformer which uses electrolytic oxygen (O₂), a hydrocarbon fuel source, and water (H₂O) to perform a partial oxidation reaction and produce auto-thermal reformed hydrogen and carbon dioxide (CO₂). The system also includes a carbon dioxide electrolyzer for receiving electricity and the carbon dioxide from the auto-thermal reformer, and performing electrolysis on the carbon dioxide. The carbon dioxide electrolyzer produces electrolytic carbon monoxide (CO) and a portion of the electrolytic oxygen provided to the auto-thermal reformer. The system also typically includes a water electrolyzer, which performs water electrolysis to produce electrolytic hydrogen and more electrolytic oxygen which can be provided to the auto-thermal reformer. In addition, the carbon monoxide produced by the carbon dioxide electrolyzer can be combined with the hydrogen produced by the auto-thermal reformer to form syngas.

### CROSS REFERENCE TO RELATED APPLICATIONS

This U.S. non-provisional patent application claims priority to U.S. provisional application no. 63/750513, filed January 28, 2025, and U.S. provisional application no. 63/876342, filed September 5, 2025, which are incorporated herein by reference in their entirety.

### BACKGROUND OF THE INVENTION

### 1. Field of the Invention

The invention relates generally to a system and method for producing hydrogen, including low-cost, low to zero-carbon, and emission-free hydrogen for fuel cell electric vehicles (FCEVs).

### 2. Related Art

Fuel cell electric vehicles (FCEVs) have been developed as an alternative to gasoline-powered vehicles and have several advantages over gasoline-powered vehicles. For example, FCEVs are more efficient than gasoline-powered vehicles and do not produce harmful emissions. FCEVs only emit water vapor, air, and heat. FCEVs include an electric motor powered by a fuel cell, rather than an internal combustion engine, and the fuel cell produces electricity from hydrogen. One challenge associated with FCEVs is the production, storage, and distribution of the hydrogen. The production of hydrogen requires a significant amount of energy, and there is currently a lack of infrastructure needed to distribute the hydrogen to electric vehicles. Thus, improvements to systems and methods for producing and distributing hydrogen are desired.

### SUMMARY

One aspect of the disclosure provides a system for producing low-cost, low to zero-carbon, and emission-free hydrogen (H₂). The system comprises an auto-thermal reformer for receiving electrolytic oxygen (O₂), a hydrocarbon fuel source, and water (H₂O). The auto-thermal reformer performs a partial oxidation reaction to produce auto-thermal reformed hydrogen (H₂) and carbon dioxide (CO₂). The system also includes a carbon dioxide (CO₂) electrolyzer for receiving electricity and the carbon dioxide (CO₂) from the auto-thermal reformer, and performing electrolysis on the carbon dioxide (CO₂). The carbon dioxide (CO₂) electrolyzer produces electrolytic carbon monoxide (CO) and a first portion of the electrolytic oxygen (O₂) received by the auto-thermal reformer.

Another aspect of the disclosure provides a method of manufacturing hydrogen (H₂). The method includes providing electrolytic oxygen (O₂), a hydrocarbon fuel source, and water (H₂O) to an auto-thermal reformer to initiate a partial oxidation reaction in the auto-thermal reformer. The partial oxidation reaction produces auto-thermal reformed hydrogen (H₂) and carbon dioxide (CO₂). The method further includes providing electricity and the carbon dioxide (CO₂) from the auto-thermal reformer to a carbon dioxide (CO₂) electrolyzer to initiate electrolysis on the carbon dioxide (CO₂) in the carbon dioxide (CO₂) electrolyzer. The electrolysis produces electrolytic carbon monoxide (CO) and a first portion of the electrolytic oxygen (O₂) provided to the auto-thermal reformer.

### BRIEF DESCRIPTION OF THE DRAWING

Other advantages of the present invention will be readily appreciated, as the same becomes better understood by reference to the following detailed description when considered in connection with the accompanying drawings wherein:

FIG. 1 is a schematic drawing of a system including an auto-thermal reformer, a carbon dioxide (CO₂) electrolyzer, and a water (H₂O) electrolyzer according to example embodiments;

FIG. 2 illustrates the auto-thermal reformer of the system according to example embodiments;

FIG. 3 illustrates the carbon dioxide (CO₂) electrolyzer of the system according to example embodiments;

FIGS. 4A and 4B show a system including only a combination of an auto-thermal reformer and a carbon dioxide (CO₂) electrolyzer according to example embodiments;

FIG. 5 illustrates the water (H₂O) electrolyzer of the system according to example embodiments;

FIG. 6 includes example input and output values for the system of FIG. 1 according to a specific example embodiment;

FIGS. 6A-1 to 6M-2 illustrate additional embodiments of components of the system and further embodiments of the system overall; and

FIG. 7 illustrates a plurality of modules each including an auto-thermal reformer, a carbon dioxide (CO₂) electrolyzer, and a water (H₂O) electrolyzer according to an example embodiment.

### DETAILED DESCRIPTION OF EXAMPLE EMBODIMENTS

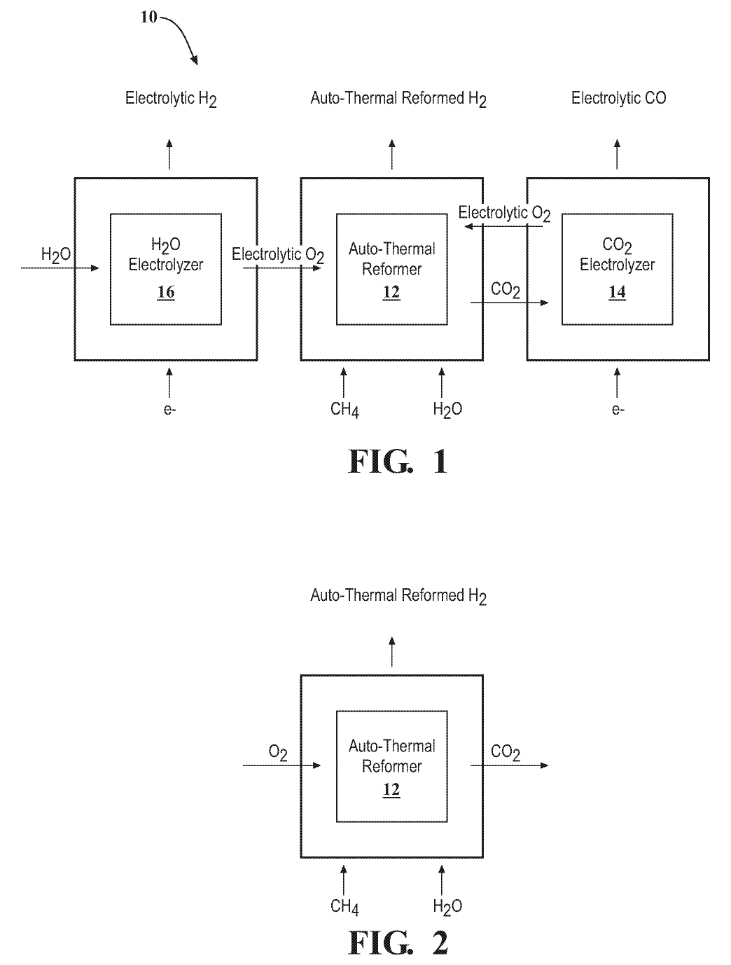

One aspect of the disclosure provides a system 10 capable of producing low-cost, zero-carbon, and emission-free hydrogen. FIG. 1 is a schematic drawing of the system 10 according to example embodiments. As shown in FIG. 1, the system preferably includes an auto-thermal reformer 12, a carbon dioxide (CO₂) electrolyzer 14, and a water (H₂O) electrolyzer 16. As shown in FIG. 1, electrons (e-) and water are provided to the water (H₂O) electrolyzer 16. The water (H₂O) electrolyzer 16 performs electrolysis on the water and produces electrolytic oxygen (O₂) and electrolytic hydrogen (H₂). The electrolytic oxygen (O₂) is provided to the auto-thermal reformer 12 along with water and a hydrocarbon fuel source, typically natural gas containing methane (CH₄). In other words, the hydrocarbon fuel source is a source of hydrogen (H₂) provided to the auto-thermal reformer 12. Other examples of the hydrocarbon fuel source are propane (C₃H₈) and other alkanes. The water provided to the auto-thermal reformer 12 is also a partial source of hydrogen. The auto-thermal reformer 12 uses the water and methane or other hydrocarbon fuel source/source of hydrogen (H₂) to produce auto-thermal reformed hydrogen (H₂) by a thermal process, such as partial oxidation. The auto-thermal reformer 12 also produces carbon dioxide (CO₂). The carbon dioxide produced by the auto-thermal reformer 12 and electrons are provided to the carbon dioxide (CO₂) electrolyzer 14. The carbon dioxide electrolyzer 14 performs electrolysis on the carbon dioxide and produces electrolytic oxygen (O₂) and electrolytic carbon monoxide (CO). The carbon dioxide electrolyzer 14 also produces electrolytic oxygen that can be provided to the auto-thermal reformer 12. The components of the system 10 will be described in future detail below.

FIG. 2 shows the auto-thermal reformer 12 of the system according to example embodiments. The auto-thermal reformer 12, also referred to as an auto thermal reformer (ATR) vessel, is used for partial oxidation of a hydrocarbon feedstock, generally methane that is present in natural gas. The inputs for the partial oxidation reaction are a source of the hydrocarbon, for example the methane, steam from water, and oxygen. The partial oxidization reaction performed by the auto-thermal reformer 12 produces the auto-thermal reformed hydrogen (H₂) and carbon dioxide (CO₂). Details related to the reaction mechanism performed by the auto-thermal reformer 12 are disclosed on the `U.S. Department of Energy website titled “Hydrogen Production: Natural Gas Reforming”, available at https://www.energy.gov/eere/fuelcells/hydrogen-production-natural-gas-reforming.

The partial oxidation reaction using the auto-thermal reformer 12 is preferred over steam-methane reforming (SMR) in the present system 10. Most hydrogen produced today in the United States is made by steam-methane reforming. Steam-methane reforming is a mature production process in which high-temperature steam, typically in the range of 700°C to 1,000°C, is used to produce hydrogen from a methane source, such as natural gas. In steam-methane reforming, methane reacts with steam under a pressure of 3 to 25 bar (1 bar = 14.5 psi) in the presence of a catalyst to produce hydrogen, carbon monoxide, and a relatively small amount of carbon dioxide. Steam methane reforming is endothermic, and thus heat must be supplied to the process for the reaction to proceed. Subsequently, in what is called a "water-gas shift reaction," the carbon monoxide and steam are reacted using a catalyst to produce carbon dioxide and more hydrogen. In a final process step called "pressure-swing adsorption," carbon dioxide and other impurities are removed from the gas stream, leaving essentially pure hydrogen.

Steam-methane reforming reaction: CH₄ + H₂O (+ heat) → CO + 3H₂

Water-gas shift reaction: CO + H₂O → CO₂ + H₂ (+ small amount of heat)

Steam reforming can also be used to produce hydrogen from other fuels, such as ethanol, propane, or even gasoline.

In the partial oxidation reaction, the methane and other hydrocarbons in natural gas react with a limited amount of oxygen, which is not enough oxygen to completely oxidize the hydrocarbons to carbon dioxide and water. The oxygen provided to the auto-thermal reformer 12 is typically obtained by separating the oxygen from nitrogen in an air separation unit (ASU). With less than the stoichiometric amount of oxygen available, the reaction products contain primarily hydrogen and carbon monoxide. The reaction products can also contain a relatively small amount of carbon dioxide and other compounds. Subsequently, in a water-gas shift reaction, the carbon monoxide reacts with water to form carbon dioxide and more hydrogen.

Partial oxidation is an exothermic process and thus gives off heat. The process is, typically, much faster than steam reforming and requires a smaller reactor vessel. As can be seen in chemical reactions of partial oxidation, this process initially produces less hydrogen per unit of the input fuel than is obtained by steam reforming of the same fuel.

The partial oxidation of methane reaction occurs as follows: CH₄ + ½O₂ → CO + 2H₂ (+ heat).

The water-gas shift reaction occurs as follows: CO + H₂O → CO₂ + H₂(+ small amount of heat).

Partial oxidation using the auto-thermal reformer 12 is preferable for several reasons. First, reforming low-cost natural gas can provide the hydrogen to power the fuel cell electric vehicles (FCEVs) as well as other applications. Over the long term, it is expected that hydrogen production from natural gas will be expanded to include the use of renewables, such as biomass, coal (with carbon capture and storage), and other low-carbon, domestic energy resources. These could be alternatives for the hydrocarbon fuel source/source of hydrogen provided to the auto-thermal reformer 12.

Petroleum use and emissions are lower using fuel cell electric vehicles compared to petroleum use and emissions of gasoline-powered internal combustion engine vehicles. The only product from an FCEV tailpipe is water vapor. Even with the upstream process of producing hydrogen from natural gas, as well as delivering and storing it for use in FCEVs, the total greenhouse gas emissions and petroleum use is reduced compared to existing gasoline vehicles. More information related to hydrogen strategy is disclosed in an article provided by the U.S. Department of Energy, Office of Fossil Energy and Carbon Management, available at: https://www.energy.gov/sites/prod/files/2020/07/f76/USDOE_FE_Hydrogen_Strategy_July2020.pdf.

To obtain pure oxygen for use in the process of auto-thermal reforming (ATR) of natural gas into hydrogen, an air separation unit (ASU) is typically used to separate the oxygen from nitrogen in air, which is typically 80% nitrogen and 20% oxygen, at an energy cost penalty. For the production of auto-thermal reformed hydrogen (H₂), each kilogram of hydrogen produced typically requires 3.7 to 5.1 kilograms of oxygen.

Auto-thermal reforming is more efficient than steam generating boilers/power plants. Specifically, auto-thermal reforming has been found to be 80% efficient, compared to 40% to 50% efficiency for steam generating boilers/power plants. In addition, capital equipment costs for auto-thermal reforming of hydrogen is less than capital equipment costs for steam-methane reforming (SMR) of hydrogen. The equipment used for auto-thermal reforming of hydrogen also scales more readily and economically. Another benefit of auto-thermal reforming of hydrogen compared to steam-methane reforming (SMR) of hydrogen is lower production costs. The CO₂ removal from the mixed H₂/CO₂ stream and compression of the CO₂ produced during the auto-thermal reforming are achieved and dependent upon the technology selected for the hydrogen plant configuration.

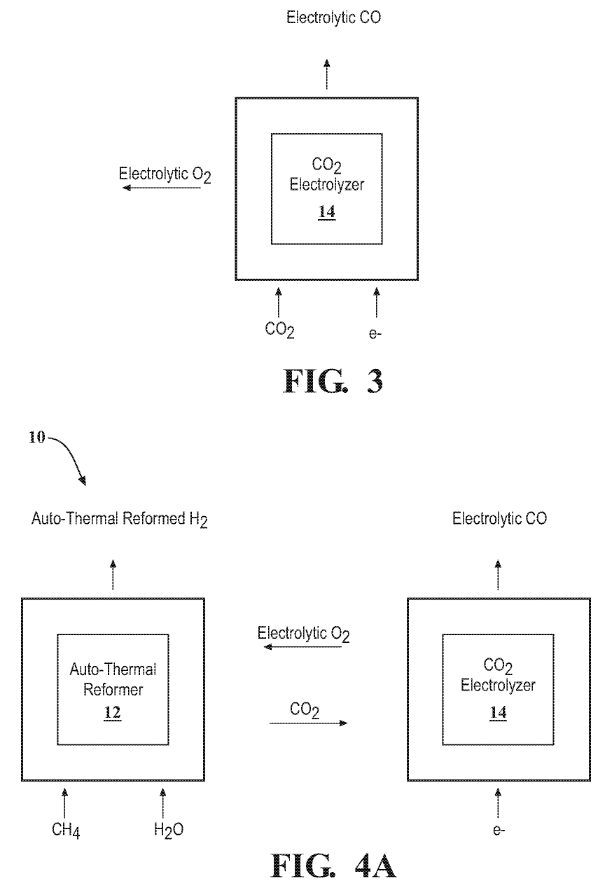

FIG. 3 illustrates the carbon dioxide (CO₂) electrolyzer 14 of the system 10 according to example embodiments. As shown in FIG. 1, the carbon dioxide (CO₂) electrolyzer 14 receives carbon dioxide from the auto-thermal reformer 12. Electrons (e-) are also provided to the carbon dioxide (CO₂) electrolyzer 14, which allows the carbon dioxide (CO₂) electrolyzer 14 to electrochemically reduce the CO₂ and separate the CO₂ into two by-products, specifically electrolytic carbon monoxide (CO) and electrolytic oxygen. The electrolytic oxygen can be provided to the auto-thermal reformer 12 for the production of the auto-thermal reformed hydrogen (H₂), as described above.

The electrochemical reduction of carbon dioxide, also known as CO₂RR, performed by the carbon dioxide (CO₂) electrolyzer 14 is the conversion of carbon dioxide (CO₂) to a more reduced chemical species using electrical energy. This reaction represents one potential step in the broad scheme of carbon capture and utilization. See Wikipedia article on carbon capture and storage available at: https://en.wikipedia.org/wiki/Carbon_capture_and_storage and Wikipedia article on electrochemical reduction of carbon dioxide available at: https://en.wikipedia.org/wiki/Electrochemical_reduction_of_carbon_dioxide.

The electrochemical reduction of carbon dioxide can produce diverse compounds including formate (HCOO⁻), carbon monoxide (CO), methane (CH₄), ethylene (C₂H₄), and ethanol (C₂H₅OH). The main challenges are the relatively high cost of electricity, compared to petroleum, and that CO₂ is often contaminated with O₂ and must be purified before reduction. For example, the electrolysis of carbon dioxide (CO₂) into carbon monoxide (CO) and oxygen (O₂) typically requires around 4.8 to 8 kilowatt-hours (kWh) per kilogram of CO produced.

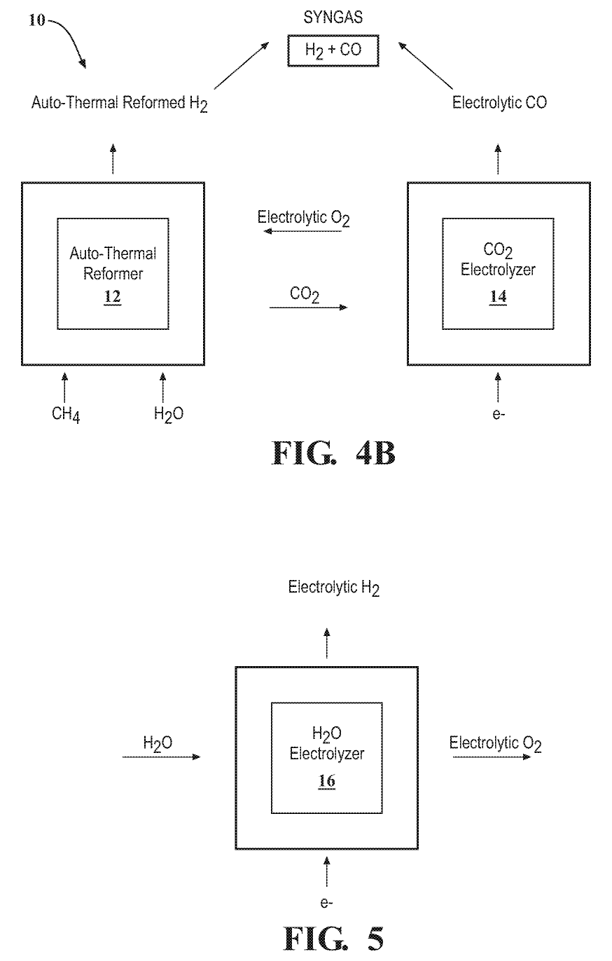

According to one example embodiment of the disclosure, as shown in FIGS. 4A and 4B, the system includes only a combination of the auto-thermal reformer 12 and the carbon dioxide (CO₂) electrolyzer 14 to produce low-cost, zero carbon and emissions free hydrogen. According to this embodiment, the system 10 enables the beneficial use of the CO₂ generated and emitted by the auto-thermal reformer 12 in the carbon dioxide (CO₂) electrolyzer 14 for the production of carbon monoxide (CO) and oxygen. The combination of the auto-thermal reformer 12 and the carbon dioxide (CO₂) electrolyzer 14 also allows for the beneficial use of the oxygen generated by the carbon dioxide (CO₂) electrolyzer 14 in the auto-thermal reformer 12 for the auto-thermal production of hydrogen. A stoichiometric reaction converts 100% of the CO₂ generated and emitted by the reaction(s) of the auto-thermal reformer 12 into the products produced by the carbon dioxide (CO₂) electrolyzer 14, carbon monoxide (CO) and oxygen. For each kilogram of CO₂ generated and emitted by the auto-thermal reformer 12, 0.36 kilograms of oxygen and 0.64 kilograms of carbon monoxide are produced.

In addition, the system of FIGS. 4A and 4B allows the carbon monoxide (CO) produced by the carbon dioxide (CO₂) electrolyzer 14 to be combined with the hydrogen produced by the auto-thermal reformer 12 to form syngas. Syngas, or synthesis gas, is a fuel gas mixture consisting primarily of hydrogen, carbon monoxide, and often some carbon dioxide. It is used as an intermediate in creating synthetic natural gas and for producing ammonia or methanol. Syngas is used primarily in the production of hydrocarbon fuels, such as diesel fuel and methanol, and in the production of industrial chemicals, particularly ammonia. Syngas is the major product of gasification and plays a vital role during pyrolysis initiated on residues, biomass, and waste.

Another benefit of the system 10 of FIGS. 4A and 4B is that the use of the CO₂ generated and emitted by the auto-thermal reformer 12 eliminates the need for capital intensive carbon capture and sequestration (CCS) of the carbon dioxide (CO2), thereby, providing for the production of zero-carbon, emissions-free hydrogen.

However, the auto-thermal production of hydrogen typically requires 5.1 kilograms of oxygen to produce 1 kilogram of hydrogen. The full and complete conversion of the carbon dioxide (CO₂) generated and emitted by the auto-thermal reformer 12 produces only 2.77 kilograms of oxygen by the carbon dioxide (CO₂) electrolyzer 14. This shortfall of oxygen (2.33 kilograms) needed for the auto-thermal reformer 12 is satisfied by the addition of the water electrolyzer 16, which will be discussed further below.

The syngas produced by the carbon dioxide (CO₂) electrolyzer 14 and the auto-thermal reformer 12 can be used to form a number of products using the Fischer-Tropsch process. The Fischer–Tropsch process involves a series of chemical reactions that produce a variety of hydrocarbons, ideally having the formula (CnH₂ n ₊₂). The more useful reactions produce alkanes as follows: (2n + 1) H₂ + n CO → CnH₂ n ₊₂ + n H₂O, where n is typically 10–20. The formation of methane (n = 1) is unwanted. Most of the alkanes produced tend to be straight-chain, suitable as diesel fuel. In addition to alkane formation, competing reactions give small amounts of alkenes, as well as alcohols and other oxygenated hydrocarbons. The reaction is a highly exothermic reaction due to a standard reaction enthalpy (ΔH) of −165 kJ/mol CO combined. For example, when n=15, the reactor includes the following: 31H₂ + 15CO = C₁₅H₃₂ + 15H₂0; 62kg-H₂ + 420kg-CO = 212kg-C₁₅H₃₂ + 270kg-H₂0. The ratio of H₂/CO = 62/420 = 0.14762. Thus, 64 x 10⁶ kg-CO will require 9.45 x 10⁶ kg-H₂ and will also generate 41.143 x 10⁶kg-H₂0.

FIG. 5 shows the water (H₂O) electrolyzer 16, also referred to as a water splitting electrolyzer, of the system 10 according to example embodiments. As explained above, electrons (e-) and water are provided to the water (H₂O) electrolyzer 16. The water (H₂O) electrolyzer 16 performs electrolysis on the water and produces electrolytic oxygen (O₂) and electrolytic hydrogen (H₂). The electrolytic oxygen (O₂) is provided to the auto-thermal reformer 12 along with water and natural gas containing methane (CH₄). In other words, the water (H₂O) electrolyzer 16 is able to produce additional oxygen, in order to satisfy the input requirement of oxygen needed for the auto-thermal reformer 12. As stated above, the oxygen needed for the auto-thermal reformer 12 is not sufficiently generated by the carbon dioxide (CO₂) electrolyzer 14, and the water (H₂O) electrolyzer 16 provides the remaining amount of oxygen needed.

The water (H₂O) electrolyzer 16 of the example embodiments also produces additional hydrogen (H₂). The water (H₂O) electrolyzer 16 is about 70% efficient with regard to the production of hydrogen. The water electrolysis process uses the electricity (e-) to split the water into hydrogen and oxygen. The overall reaction can be divided into two half-cell reactions, including a hydrogen evolution reaction (HER) and an oxygen evolution reaction (OER). This reactions take place in the water (H₂O) electrolyzer 16.

The water (H₂O) electrolyzer 16 can range in size from a small, appliance-size piece of equipment that is well-suited for small-scale distributed hydrogen production, to a size sufficient for large-scale, central production facilities that could be tied directly to renewable or other non-greenhouse-gas-emitting forms of electricity production. Like fuel cells, the water (H₂O) electrolyzer 16 includes an anode and a cathode separated by an electrolyte. The water (H₂O) electrolyzer 16 can function in different ways, depending on the type of electrolyte material involved and the ionic species the electrolyte material conducts. Various different electrolyte materials can be used in the water (H₂O) electrolyzer 16.

According to one example embodiment, the water (H₂O) electrolyzer 16 could include a polymer electrolyte membrane (PEM) for the electrolyte material. In this case, the electrolyte is typically a solid specialty plastic material. Water reacts at the anode to form oxygen and positively charged hydrogen ions (protons). The electrons flow through an external circuit and the hydrogen ions selectively move across the polymer electrolyte membrane to the cathode. At the cathode, hydrogen ions combine with electrons from an external circuit to form hydrogen gas. The anode reaction is as follows: 2H₂O → O₂ + 4H⁺ + 4e⁻. The cathode reaction is as follows: 4H⁺ + 4e⁻ → 2H₂.

According to another example embodiment, the water (H₂O) electrolyzer 16 could include an alkaline electrolyte material. This type of electrolyzer operates by transporting hydroxide ions (OH⁻) through the alkaline electrolyte material from the cathode to the anode and generates the hydrogen on the cathode side. The alkaline electrolyte material can include a liquid alkaline solution of sodium or potassium hydroxide, for example. Alternatively, the electrolyte material could include a solid alkaline exchange membrane (AEM).

According to yet another example embodiment, the water (H₂O) electrolyzer 16 could include solid oxide electrolyte material (SOEC). According to this embodiment, the electrolyte material is a solid ceramic material which selectively conducts negatively charged oxygen ions (O²⁻) at elevated temperatures, and generates hydrogen in a different way compared to other types of electrolyzers. Steam at the cathode combines with electrons from the external circuit to form hydrogen gas and negatively charged oxygen ions. The oxygen ions passes through the solid ceramic membrane and reacts at the anode to form oxygen gas and generate electrons for the external circuit. The water (H₂O) electrolyzer 16 including the solid oxide electrolyte material must operate at a temperature high enough for the solid oxide membrane to function properly. The solid oxide electrolyzer operates at about 700° to 800°C, compared to a PEM electrolyzers, which typically operate at 70° to 90°C, and commercial alkaline electrolyzers, which typically operate at less than 100°C. Some solid oxide electrolyzers based on proton-conducting ceramic electrolytes may be able to lower the operating temperature to 500° to 600°C. The solid oxide electrolyzers can effectively use heat available at these elevated temperatures, including heat from various sources to decrease the amount of electrical energy needed to produce the hydrogen from water.

The water electrolysis process performed by the water (H₂O) electrolyzer 16 can help achieve the goal of reducing the cost of clean hydrogen. Hydrogen produced via electrolysis can result in zero greenhouse gas emissions, depending on the source of the electricity used. The source of the required electricity, including its cost and efficiency, as well as emissions resulting from electricity generation, must be considered when evaluating the benefits and economic viability of hydrogen production via electrolysis. In many regions, the power grid may not be ideal for providing the electricity required for electrolysis because of the greenhouse gases released and the amount of fuel required, due to the low efficiency of the electricity generation process. Hydrogen production via electrolysis is being pursued for renewable energy, such as wind, solar, hydro, and geothermal energy options. These hydrogen production pathways result in virtually zero greenhouse gas and criteria pollutant emissions. However, the production cost needs to be decreased significantly to be competitive with more mature carbon-based pathways, such as natural gas reforming.

Hydrogen production via the water electrolysis process may also offer opportunities for synergy with dynamic and intermittent power generation, which is characteristic of some renewable energy technologies. For example, though the cost of wind power has continued to drop, the inherent variability of wind is an impediment to the effective use of wind power. Hydrogen fuel and electric power generation could be integrated at a wind farm, allowing flexibility to shift production to best match resource availability with system operational needs and market factors. Also, in times of excess electricity production from wind farms, instead of curtailing the electricity as is commonly done, it is possible to use this excess electricity to produce hydrogen through electrolysis.

As indicated above, the system 10 according to the present disclosure, which typically includes the combination of the auto-thermal reformer 12, the carbon dioxide (CO₂) electrolyzer 14, and the water (H₂O) electrolyzer 16, as shown in FIG. 1, provides numerous benefits. The system 10 can provide a turn-key onsite single train energy power plant, much like a current refinery. Not shown in FIG. 1 is the ancillary equipment that may be required for operation of the system 10, including but not limited to, storage tanks, piping, compressors, a water gas shift unit, a pressure swing absorber unit and a carbon dioxide (CO₂) removal unit. The system 10 is also capable of using renewable electricity. Operational production costs could be reduced by using electricity off the grid at standard industrial rates for electricity.

It is estimated that the system 10 according to example embodiments could produce approximately 1.07 x 10⁶ gallons of fuel (6.3 x 10⁶ kg of CO + 930 x 10³ kg of ATR H₂) + 370 x 10³ kg of ATR H₂ or enough hydrogen fuel for approximately 1850 FCEVs per year. An additional ancillary 675 x 10³ kg of H₂ produced by a 5MW electrolyzer could fuel an additional 3375 FCEVs per year. Thus, the FCEVs fueled per year= 1850 + 3375 = 5225.

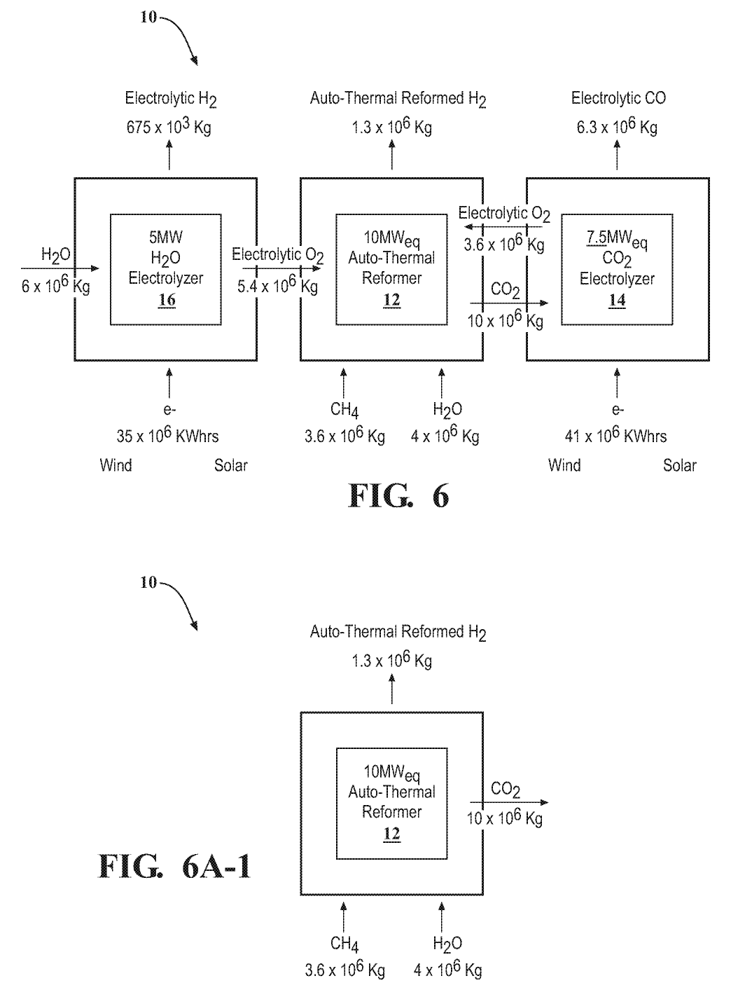

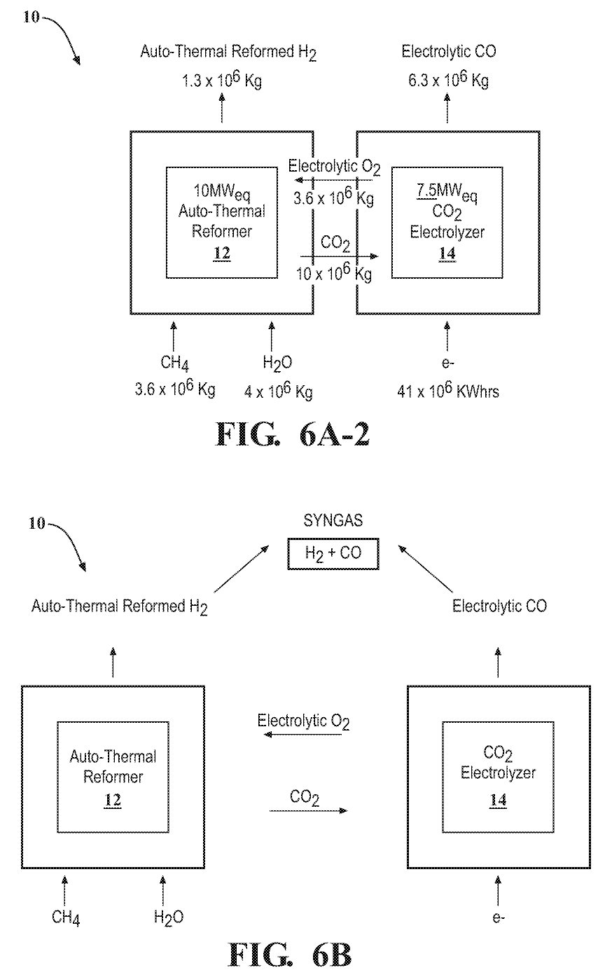

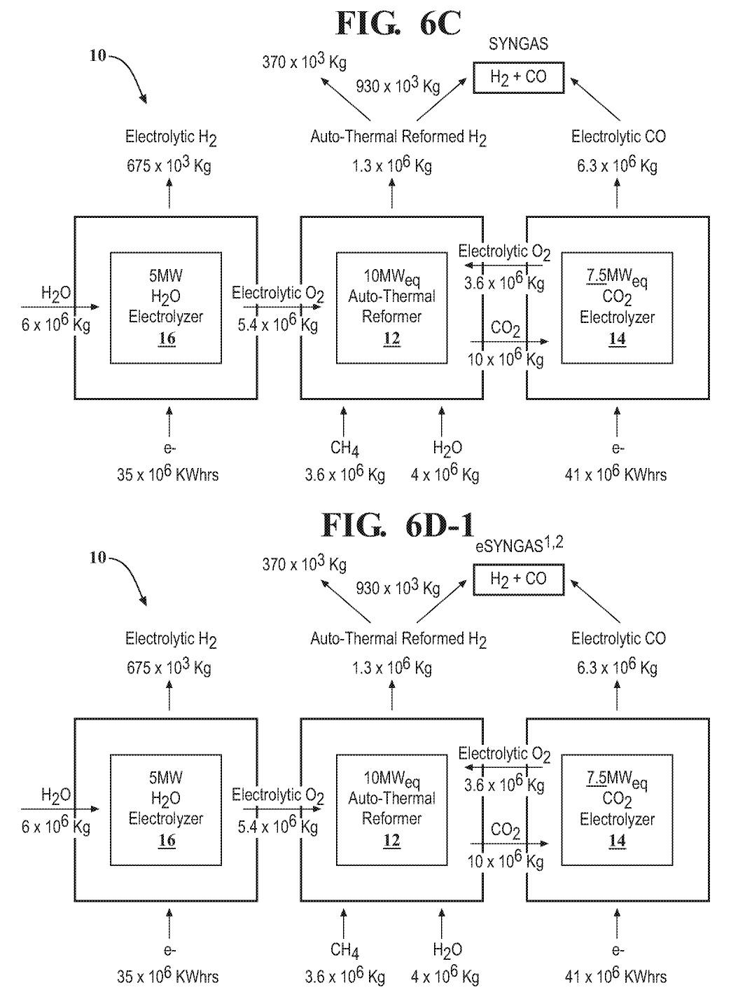

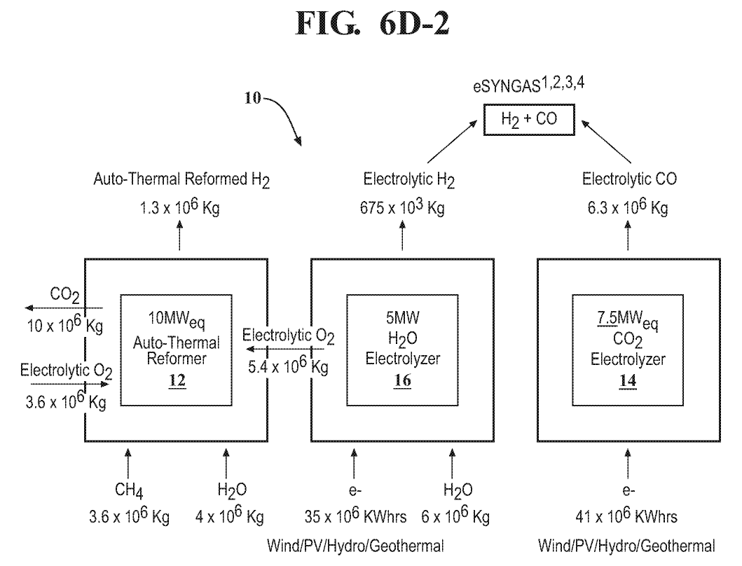

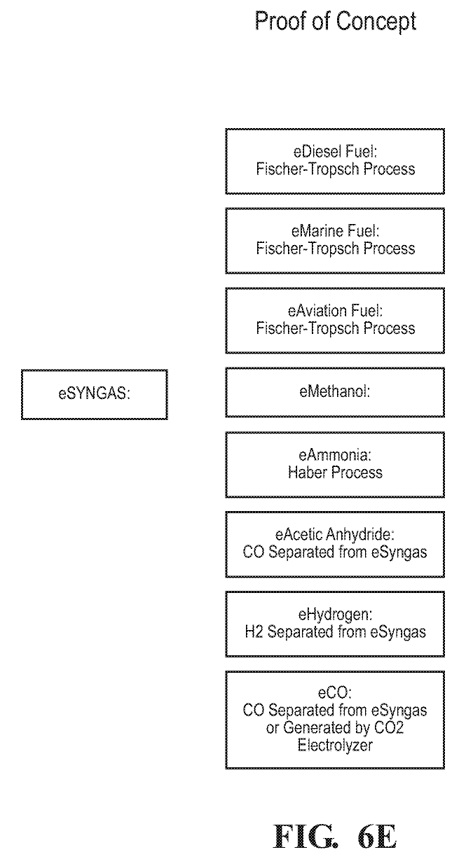

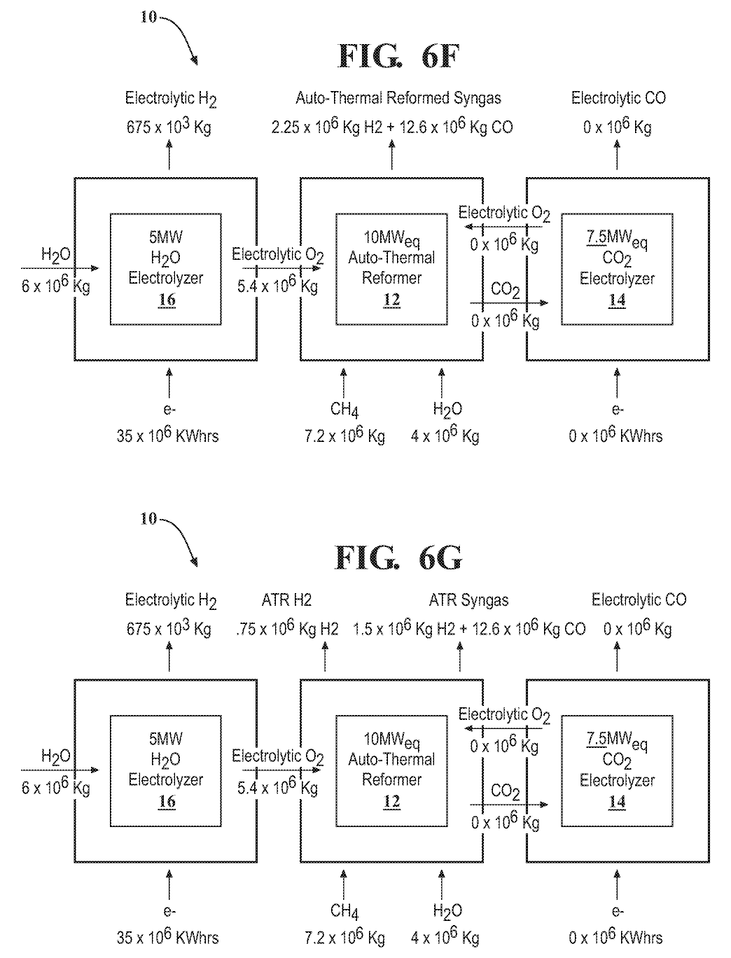

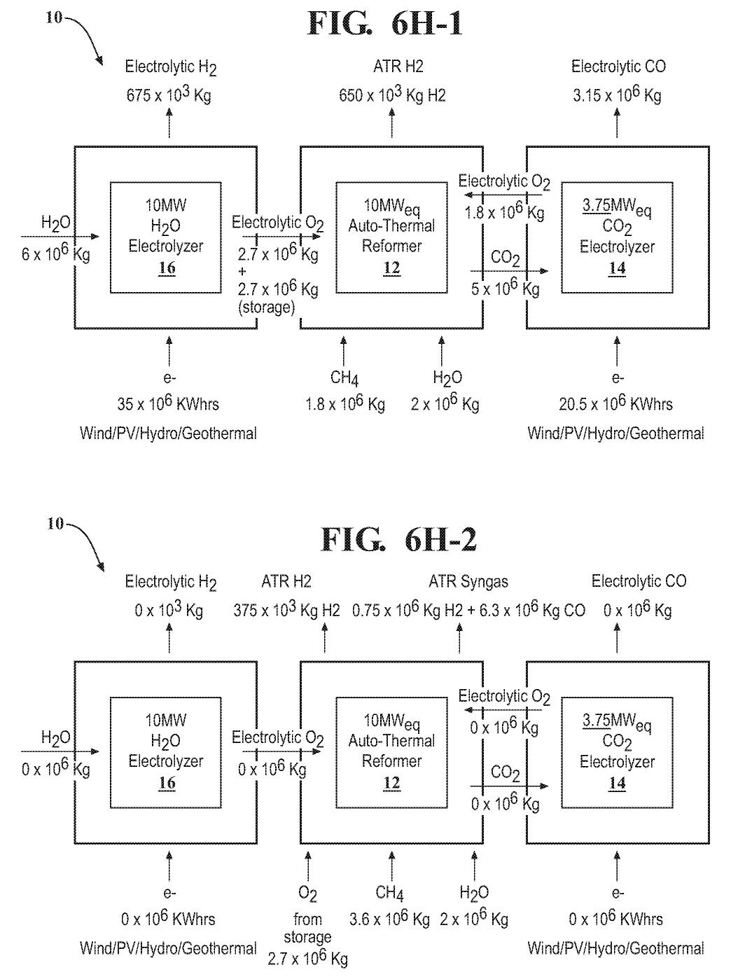

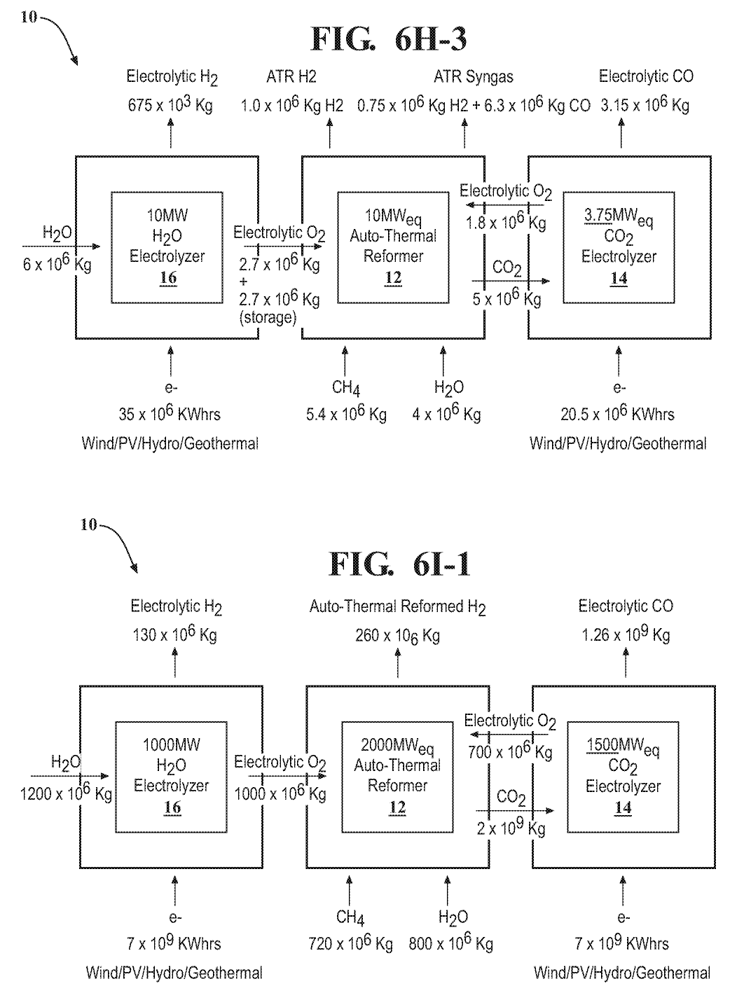

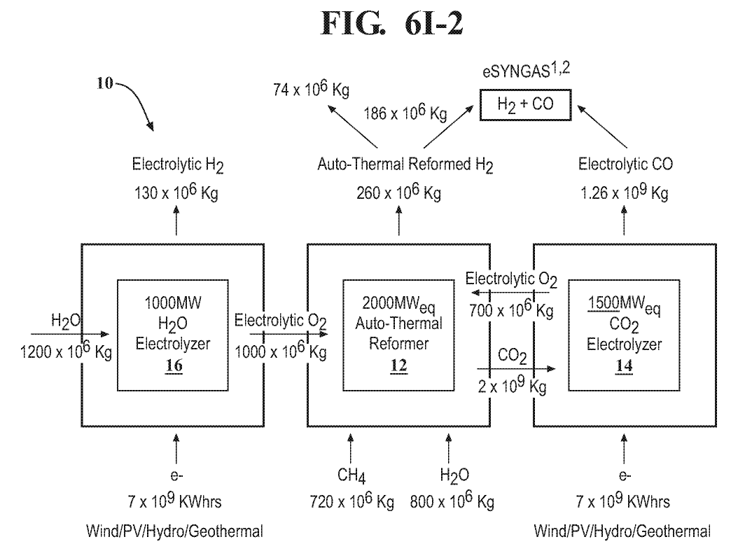

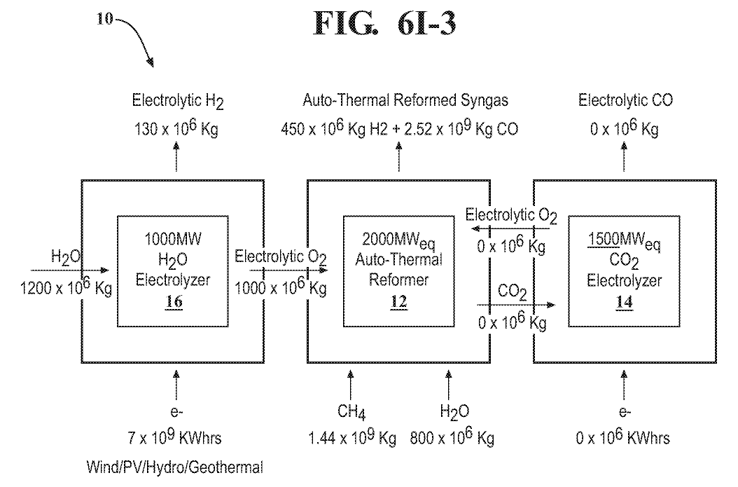

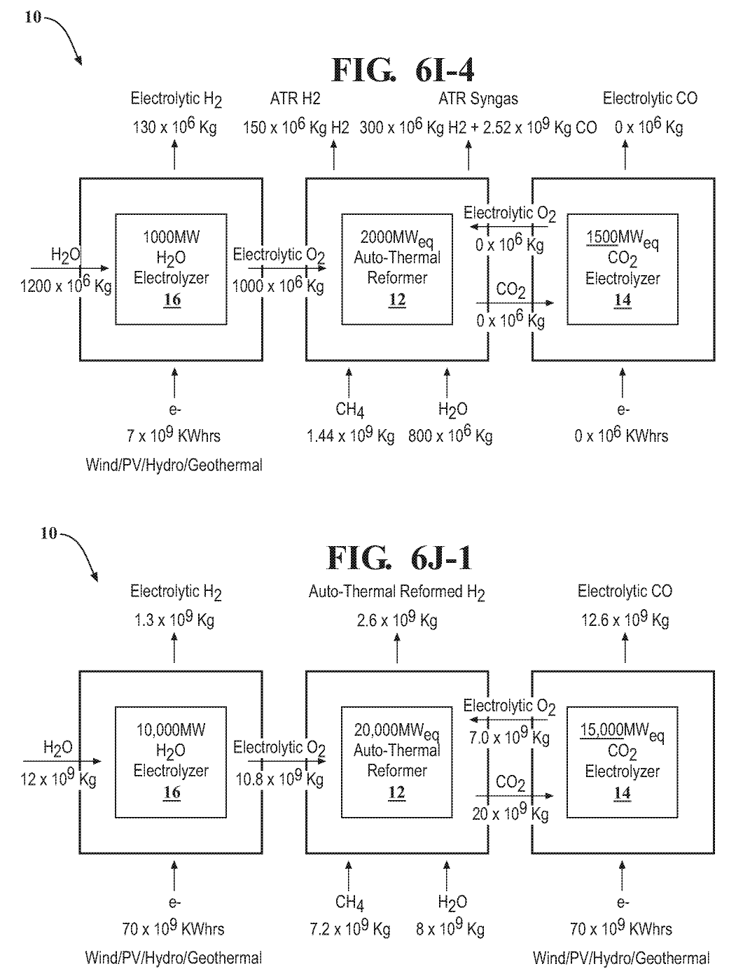

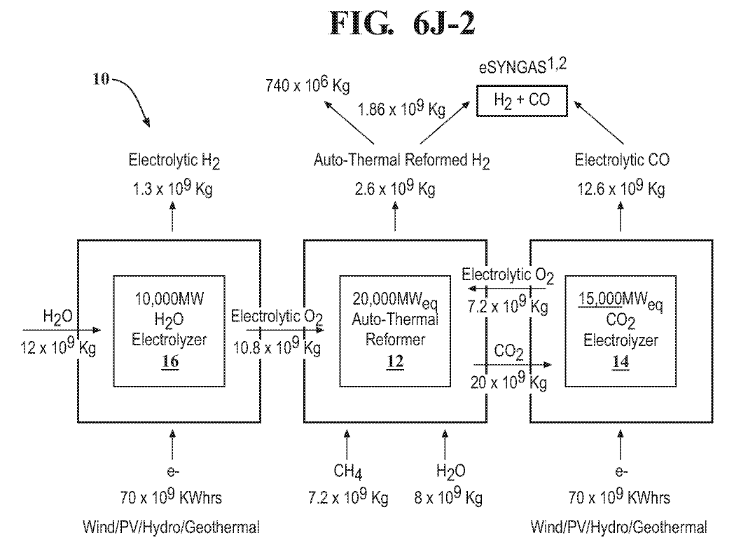

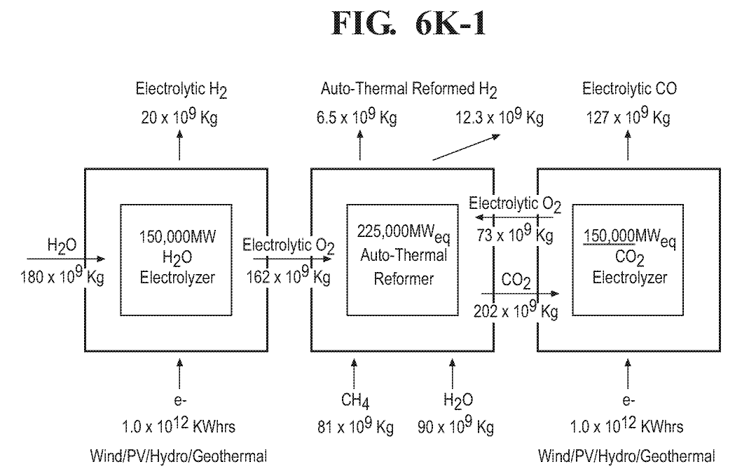

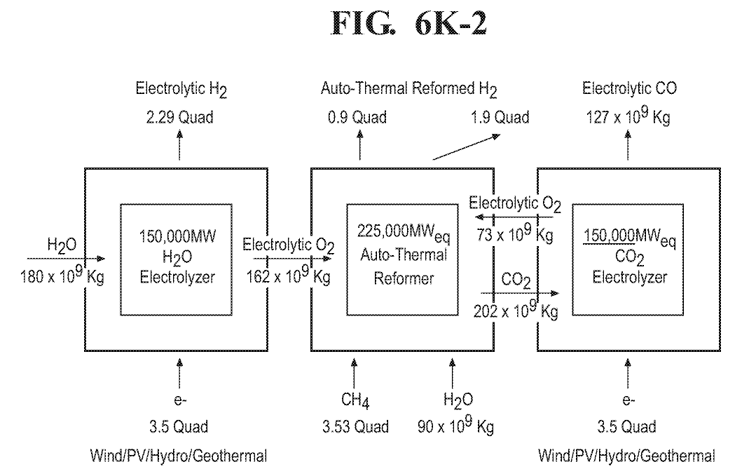

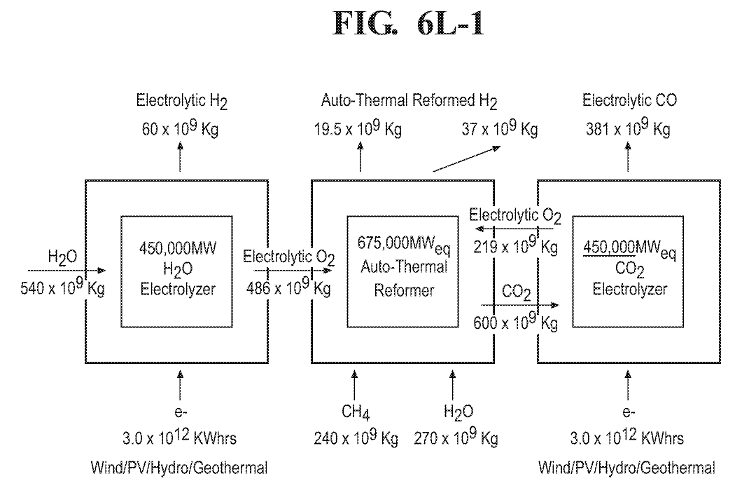

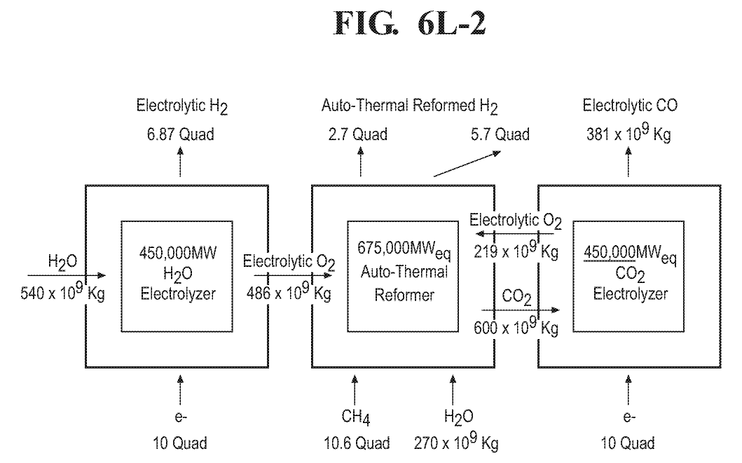

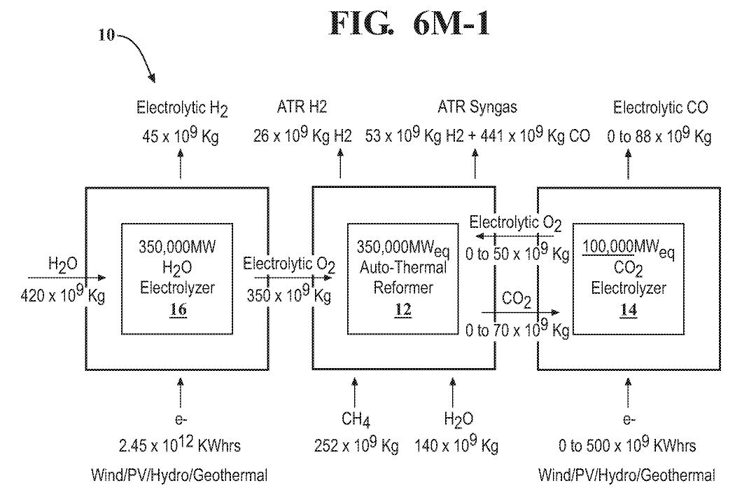

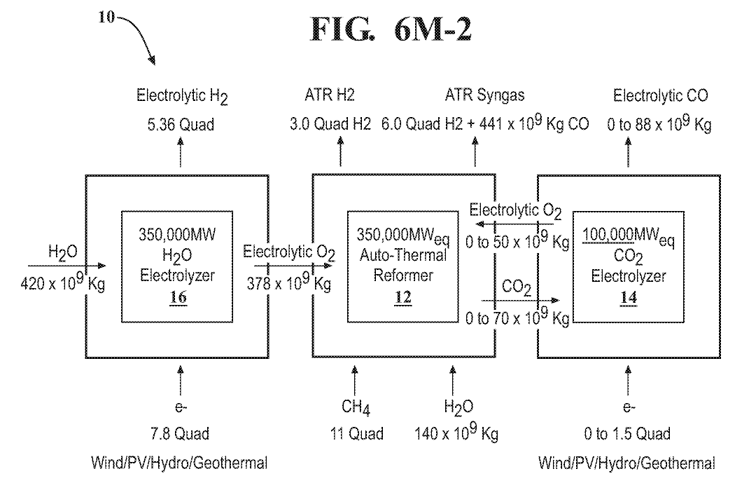

The capital costs expected in order to make and use the system 10 according to example embodiments include costs for a power plant facility, the auto-thermal reformer 12, the carbon dioxide (CO₂) electrolyzer 14, and the water (H₂O) electrolyzer 16. The annual operating costs expected for inputs to the system 10 include the costs for methane, renewable electricity for the carbon dioxide (CO₂) electrolyzer 14, renewable electricity for the water (H₂O) electrolyzer 16, water, and the conversion of the syngas to fuel using a Fischer–Tropsch process. The expected outputs include the fuel, such as diesel fuel, and the hydrogen. Example input and output values relevant to the system 10 according to a specific example embodiment is shown in FIG. 6. The value of the outputs from the system 10 is expected to be significantly greater than the cost of the inputs.

Additional embodiments of the components of the system 10, and further embodiments of the system 10 overall, are shown in FIGS. 6A-1-6L-2.

FIG. 6A-1 illustrates another embodiment of the auto-thermal reformer 12 used to produce hydrogen, which can be a key component of a refinery/combined cycle power plant. Hydrocarbons, most commonly natural gas (methane), water and oxygen are inputs to the auto-thermal reformer 12 and hydrogen and carbon dioxide are outputs. Another output is carbon monoxide, which will be discussed later.

FIG. 6A-2 illustrates another embodiment of the carbon dioxide (CO₂) electrolyzer 14 in combination with the auto-thermal reformer 12 according to an example embodiment. The auto-thermal reformer 12 is joined to the carbon dioxide (CO₂) electrolyzer 14. Inputs to the carbon dioxide (CO₂) electrolyzer 14 include CO₂ from the auto-thermal reformer 12 and electricity for the electrolysis of the CO₂ from the auto-thermal reformer 12. Outputs from the carbon dioxide (CO₂) electrolyzer 14 include oxygen for the auto-thermal reformer 12 and carbon monoxide. The carbon dioxide (CO₂) electrolyzer 14 is sized to electrolyze the potential maximum amount of CO₂ generated from the auto-thermal reformer 12. Since the auto-thermal reformer 12 uses oxygen generated by the carbon dioxide (CO₂) electrolyzer 14, no oxides of nitrogen (NOX) are generated or emitted by the system 10. Also, no air separation unit (ASU) is required by the system 10. No energy and cost penalties are required to separate the oxygen from air (80% N₂ + 20% O₂). In addition, the system could use off the grid electricity or renewable electricity, and thus operational production costs could be reduced using the electricity off the grid at standard industrial rates for electricity.

FIG. 6B is another version of the components shown in FIG. 4B. According to this embodiment, hydrogen (H₂) from the auto-thermal reformer 12 is combined with carbon monoxide (CO) from the carbon dioxide (CO₂) electrolyzer 14 to form syngas (H₂ + CO). The syngas can be used to form a number of products using the Fischer-Tropsch process, which involves a series of chemical reactions that produce a variety of hydrocarbons, ideally having the formula (CnH₂ n ₊₂). The more useful reactions produce alkanes as follows:

(2n + 1) H₂ + n CO → CnH₂ n ₊₂ + n H₂O where n is typically 10–20.

The formation of methane (n = 1) is unwanted. Most of the alkanes produced tend to be straight-chain, suitable as diesel fuel. In addition to alkane formation, competing reactions give small amounts of alkenes, as well as alcohols and other oxygenated hydrocarbons. The reaction is a highly exothermic reaction due to a standard reaction enthalpy (ΔH) of −165 kJ/mol CO combined. For example:

with n=15: 31H₂ + 15CO = C₁₅H₃₂ + 15H₂0; mole ratio of H₂:CO is: 2:1

62kg-H₂ + 420kg-CO = 212kg-C₁₅H₃₂ + 270kg-H₂O.

Mass (weight) ratio of H₂/CO = 62/420 = 0.14762.

As discussed above and shown in FIG. 6, the water (H₂O) electrolyzer 16 can be added to the system 10 for the generation of additional oxygen and additional hydrogen. Inputs to the water (H₂O) electrolyzer 16 include H₂O and electricity. Outputs from the water (H₂O) electrolyzer 16 include electrolytic hydrogen and electrolytic oxygen, which is used by the auto-thermal reformer 12. The water (H₂O) electrolyzer 16 can be sized large enough to produce additional hydrogen for fuel cell electric vehicles (FCEVs) and produce additional oxygen for the auto-thermal reformer 12. The carbon dioxide (CO₂) electrolyzer 14 may not produce the required amount of oxygen for the auto-thermal reformer 12 to perform at maximum capacity and/or efficiently for the production of hydrogen. Since the auto-thermal reformer 12 uses oxygen generated by the carbon dioxide (CO₂) electrolyzer 14 and/or the water (H₂O) electrolyzer 16, no oxides of nitrogen (NOX) are generated or emitted by the system 10. Also, no air separation unit (ASU) is required, and energy and cost penalties required to separate the oxygen from air (80% N₂ + 20% O₂) are not required. The system 10 according to this embodiment could also use off the grid electricity or renewable electricity. Operational production costs could be reduced using electricity off the grid at standard industrial rates for electricity.

FIG. 6C illustrate another embodiment of the system 10 wherein hydrogen (H₂) from the auto-thermal reformer 12 is combined with carbon monoxide (CO) from the carbon dioxide (CO₂) electrolyzer 14 to form syngas (H₂ + CO). According to this embodiment, some of the hydrogen from the auto-thermal reformer 12 can be used to form syngas with the carbon monoxide (CO) from the carbon dioxide (CO₂) electrolyzer 14, and some of the hydrogen from the auto-thermal reformer 12 can be used to fuel FCEVs.

FIG. 6D-1 shows an embodiment of the system 10 wherein the syngas created in FIGS. 6B and 6C is eSYNGAS. The hydrogen from the auto-thermal reformer 12 is low/zero carbon hydrogen. i.e., eHYDROGEN, since the CO₂ generated by the auto-thermal reformer 12 is recycled/reused by the carbon dioxide (CO₂) electrolyzer 14 and is therefore not emitted to the air. The CO generated by the carbon dioxide (CO₂) electrolyzer 14 recycles the CO₂ generated from the auto-thermal reformer 12 to generate eCO. The eSYNGAS generated can be used to produce eFUELS and eCHEMICALS. E-fuels, like e-kerosene, e-methane, or e-methanol, are made by synthesizing captured CO₂ emissions and hydrogen produced using renewable or CO₂-free electricity. The fuels release CO₂ into the atmosphere when used in an engine. Those emissions are preferably equal to the amount taken out of the atmosphere to produce the fuel, making it CO₂-neutral overall. An example of the eSYNGAS generated in this embodiment to produce eFUEL, SAF (sustainable aviation fuel), using the Fischer-Tropsch process is provided below.

The Fischer–Tropsch process involves a series of chemical reactions that produce a variety of hydrocarbons, ideally having the formula (CₙH₂ₙ₊₂). The more useful reactions produce alkanes as follows:

(2n + 1) H₂ + n CO → CₙH₂ₙ₊₂ + n H₂O where n is typically 10–20. The formation of methane (n = 1) is unwanted. Most of the alkanes produced tend to be straight-chain, suitable as diesel fuel. In addition to alkane formation, competing reactions give small amounts of alkenes, as well as alcohols and other oxygenated hydrocarbons. The reaction is a highly exothermic reaction due to a standard reaction enthalpy (ΔH) of −165 kJ/mol CO combined.

For example, with n=15: 31H₂ + 15CO = C₁₅H₃₂ + 15H₂O; the mole ratio of H₂:CO is: 2:1.

62kg-H₂ + 420kg-CO = 212kg-C₁₅H₃₂ + 270kg-H₂0.

Mass (weight) ratio of H₂/CO = 62/420 = 0.14762.

6.3 x 10⁶ kg-CO will require 930 x 10³ kg-H₂.

According to this example, the system of FIG. 6D-1 would produce approximately 2.45 x 10⁶ gallons of sustainable aviation fuel (6.3 x 10⁶ kg of CO + 930 x 10³ kg of ATR H₂) + 370 x 10³ kg of ATR H₂ or enough hydrogen fuel for approximately 125 Class 8 FCEV trucks per year (3000 kg-H2/truck) or 1850 standard FCEVs (200 kg-H2/FCEV).The additional ancillary 675 x 10³ kg of H₂ produced by the 5MW water (H₂O) electrolyzer 16 would fuel an additional 225 Class 8 FCEV trucks per year (3000 kg-H2/truck) or 3375 standard FCEVs per year. Total Class 8 FCEVs fueled/year = 125 + 225 = 350; or 5225 standard FCEVs fueled/yr.

The water (H₂O) electrolyzer 16 of FIG. 6D-1 can be oversized to produce additional hydrogen for fuel cell electric vehicles (FCEVs). The system 10 according to this embodiment can also use renewable electricity. In addition, operational production costs could be reduced using electricity off the grid at standard industrial rates for electricity.

FIG. 6D-2 illustrates the system according to another example embodiment, wherein the H₂O electrolytic hydrogen is generated in water (H₂O) electrolyzer 16 using renewable electricity, for example wind, photovoltaic (PV), hydro, and geothermal. The electrolytic carbon monoxide (CO) generated by the carbon dioxide (CO₂) electrolyzer 14 is generated using the renewable electricity. The CO generated by the carbon dioxide (CO₂) electrolyzer 14 recycles the CO₂ generated from the auto-thermal reformer 12 to generate eCO. The H₂O electrolytic hydrogen generated by the water (H₂O) electrolyzer 16 is combined with the carbon monoxide (CO) from the carbon dioxide (CO₂) electrolyzer 14 to form eSYNGAS.

The syngas created by the system 10 of FIG. 6D-2 is eSYNGAS. Therefore, the eSYNGAS generated in the embodiment depicted in FIG. 6D-2 above can be used to produce eFUELS and eCHEMICALS. Example of the eSYNGAS generated in this embodiment to produce eFUEL, SAF (sustainable aviation fuel), using the Fischer-Tropsch process is as follows.

The Fischer–Tropsch process involves a series of chemical reactions that produce a variety of hydrocarbons, ideally having the formula (CₙH₂ₙ₊₂). The more useful reactions produce alkanes as follows.

(2n + 1) H₂ + n CO → CₙH₂ₙ₊₂ + n H₂O, where n is typically 10 – 20. The formation of methane (n = 1) is unwanted. Most of the alkanes produced tend to be straight-chain, suitable as diesel fuel. In addition to alkane formation, competing reactions give small amounts of alkenes, as well as alcohols and other oxygenated hydrocarbons.The reaction is a highly exothermic reaction due to a standard reaction enthalpy (ΔH) of −165 kJ/mol CO combined.^{[9]} For example, with n=15: 31H₂ + 15CO = C₁₅H₃₂ + 15H₂0; mole ratio of H₂:CO is: 2:1

62kg-H₂ + 420kg-CO = 212kg-C₁₅H₃₂ + 270kg-H₂0.

Mass (weight) ratio of H₂/CO = 62/420 = 0.14762.

The above embodiment has a H₂:CO mole ratio of 675 x 10³ kg-H₂/2: 6.3 x 10⁶ kg-CO/28 = 1.5.

For a higher H₂:CO ratio, hydrogen from the auto-thermal reformer 12 could be added to the carbon monoxide from the carbon dioxide (CO₂) electrolyzer 14 and the hydrogen from the water (H₂O) electrolyzer 16.

An example for a H₂:CO mole ratio of 2:1 includes the following:

6.3 x 10⁶ kg-CO will require 930 x 10³ kg-H₂ .

It is noted that the above embodiment is 930 x 10³ kg H2 – 675 x 10³ kg H2, or, 255 x 10³ kg H₂ short of required renewable hydrogen. So, one could take 255 x 10³ kg-H₂ from the 1.3 x 10⁶ kg of ATR generated H₂, leaving 1.05 x 10⁶ kg H2 to fuel the Class 8 FCV trucks; 350 trucks at 3000 kg-H2 per year. This would produce approximately 2.45 x 10⁶ gallons of sustainable aviation fuel (6.3 x 10⁶ kg of CO + 675 x 10³ kg of H₂O electrolytic H₂ + 255 x 10³ kg of ATR H₂); Total of 7.23 x 10⁶ kg of eSYNGAS; 7.23 x 10⁶ kg of eSYNGAS x 2.2 lbs/kg = 15.9 x 10⁶ lbs of eSYNGAS or 2.45 x 10⁶ gallons of sustainable aviation fuel (15.9 x 10⁶ lbs/6.5 lbs per gallon of SAF). Also produced would be + 1.050 x 10⁶ kg of ATR H₂ or enough hydrogen fuel for approximately 350 Class 8 FCEV trucks per year (3000 kg-H2/truck) or 5250 standard FCEVs (200 kg-H2/FCEV).

The system 10 according to the above embodiment would also generate 4.05 x 10⁶ kg-H₂0 that can be recycled/reused by the auto-thermal reformer 12 and/or the water (H₂O) electrolyzer 16.

FIG. 6E is a non-exclusive list of products that could be made from the eSYNGAS generated in FIG. 6D-1 and 6D-2. The products that could be made from the eSYNGAS depicted in the previous Figures are ePRODUCTS that include, but are not limited to: eDiesel Fuel, eMarine Fuel, eAviation Fuel, eMethanol, eAmmonia, eAcetic Anhydride (CO separated from eSyngas) and eHydrogen (H₂ separated from eSyngas). To produce/synthesize the above listed ePRODUCTS, a different and specific eSYNGAS H2/CO ratio is required. Also, a specific (H₂-CO₂)/(CO+CO₂) ratio, called stoichiometric number, may be required.

FIG. 6F illustrates fuels switching and device switching capability of the system 10. This embodiment allows the next generation refinery/combined cycle power plant to meet changes in market demand for products, market prices for products, and cost of inputs, including the cost of electricity.

According to the example of FIG. 6F, the carbon dioxide (CO₂) electrolyzer 14 can be turned off (possibly due to high electricity costs), and the auto-thermal reformer 12 can function as either a 1) SYNGAS Plant (mixture of H₂ + CO) a 2) HYCO Plant (separate streams of H2 and CO) or a 3) Combination Plant (H₂/CO/Syngas) producing all three products.

In the above embodiment, the natural gas (methane) input has been increased (2X) which results in the “plant” performing as a SYNGAS Plant. Since no CO₂ is generated in this embodiment/configuration, there is no need to run the carbon dioxide (CO₂) electrolyzer 14. The water (H₂O) electrolyzer 16 has been intentionally oversized to produce “additional” hydrogen for fuel cell electric vehicles (FCEVs). The system 10 according to this embodiment uses renewable electricity. Operational production costs could be reduced using electricity off the grid at standard industrial rates for electricity.

FIG. 6G shows an embodiment wherein additional fuels switching and device switching capability can be achieved by the system 10. This flexibility allows the next generation refinery/combined cycle power plant to meet changes in market demand for products, market prices for products, and costs of inputs, including the cost of electricity.

According to the example of FIG. 6G, the carbon dioxide (CO₂) electrolyzer 14 can be turned off (possibly due to high electricity costs). The auto-thermal reformer 12 can function as either a 1) SYNGAS Plant (mixture of H2 + CO), a 2) HYCO Plant (separate streams of H₂ and CO), or a 3) combination Plant (H₂/CO/Syngas) producing all three products and providing flexible fuels switching capability for all three configurations and products on an hourly/daily/weekly/monthly/annual rate. The products provided can be based upon product demand, market conditions and cost of electricity.

In the above embodiment, the plant runs as a combination plant (H₂/CO/Syngas) producing all three products and providing flexible fuels switching capability for all three configurations and products on an hourly/daily/weekly/monthly/annual rate. The products provided can be based upon product demand, market conditions and cost of electricity. In the above embodiment, the natural gas (methane) input into the auto-thermal reformer 12 has been increased (2X) with no CO₂ produced. Since no CO₂ is generated in this embodiment, there is no need to run Device 2, the carbon dioxide (CO₂) electrolyzer 14. Also according to this embodiment, the water (H₂O) electrolyzer 16 has been intentionally oversized to produce “additional” hydrogen for fuel cell electric vehicles (FCEVs). The system of FIG. 6G uses renewable electricity. Operational production costs could be reduced using electricity off the grid at standard industrial rates for electricity.

FIG. 6H-1 shows additional fuels switching and device switching capability of the system 10 using a diurnal (day & night) mode of operation according to an example embodiment. This embodiment provides for use of renewable electricity for both the carbon dioxide (CO₂) electrolyzer 14 and the water (H₂O) electrolyzer 16 during day-time operation and the shutdown of these two devices during the night and use of stored oxygen from the daytime operation of the water (H₂O) electrolyzer 16 for the continuing operation of the auto-thermal reformer 12 at night. In particular, FIG. 6H-1 shows the daytime mode of operation and the mass balance of inputs and outputs of the system 10. This flexibility in the different modes of operation allows the next generation refinery/combined cycle power plant to meet changes in market demand for products, market prices for products, cost of inputs, including the cost of electricity. In the system 10 shown in FIG. 6H-1, the auto-thermal reformer 12 can function as either a syngas plant (mixture of H₂ + CO); a HYCO Plant (separate streams of H₂ and CO), or a combination plant producing all three products (H₂/CO/syngas) and providing flexible fuels switching capability for all three configurations and products on an hourly, daily/weekly, monthly, or annual rate, based upon product demand, market conditions and cost of electricity. According to this example embodiment, the plant runs as a HYCO Plant (separate streams of H₂ and CO) during the day. The water (H₂O) electrolyzer 16 of this embodiment has been intentionally oversized to produce “additional” oxygen for both the daytime operation of the auto-thermal reformer 12 and the production and storage of oxygen for the nighttime operation of the auto-thermal reformer 12. The system 10 of this embodiment uses renewable electricity. Operational production costs could be reduced using electricity off the grid at standard industrial rates for electricity.

FIG. 6H-2 shows additional fuels switching and device switching capability of the system 10 using a diurnal (day & night) mode of operation according to an example embodiment. This embodiment provides for use of renewable electricity for both the carbon dioxide (CO₂) electrolyzer 14 and the water (H₂O) electrolyzer 16 during day-time operation and the shutdown of these two devices during the night and use of stored oxygen from the daytime operation of the water (H₂O) electrolyzer 16 for the continuing operation of the auto-thermal reformer 12 at night. FIG. 6H-2 also shows the nighttime mode of operation and the mass balance of inputs and outputs of the system 10. This flexibility in the different modes of operation allows the next generation refinery/combined cycle power plant to meet changes in market demand for products, market prices for products, and cost of inputs, including the cost of electricity. According to this example embodiment, the auto-thermal reformer 12 can function as either a syngas plant (mixture of H₂ + CO), a HYCO Plant (separate streams of H₂ and CO), or a combination plant producing all three products (H₂/CO/syngas) and providing flexible fuels switching capability for all three configurations and products on an hourly, daily, weekly, monthly, or annual rate, based upon product demand, market conditions and cost of electricity. In the embodiment of FIG. 6H-2, with the carbon dioxide (CO₂) electrolyzer 14 and the water (H₂O) electrolyzer 16 turned off (possibly due to high electricity costs and/or the unavailable use of nighttime renewable electricity, i.e., PV electricity), the plant runs as a combination plant producing all three products (H₂/CO/syngas). In the above embodiment, the natural gas (methane) input into the auto-thermal reformer 12 has been increased (two times) with no CO₂ produced. Since no CO₂ is generated in this embodiment/configuration, there is no need to run carbon dioxide (CO₂) electrolyzer 14. The water (H₂O) electrolyzer 16 of this embodiment has been intentionally oversized to produce “additional” oxygen for both the daytime operation of auto-thermal reformer 12 and the production and storage of oxygen for the nighttime operation of the auto-thermal reformer 12. The system 10 of this embodiment uses renewable electricity. Operational production costs could be reduced using electricity off the grid at standard industrial rates for electricity.

FIG. 6H-3 shows additional fuels switching and device switching capability of the system 10 using a diurnal (day & night) mode of operation according to an example embodiment. This embodiment provides for use of renewable electricity for both the carbon dioxide (CO₂) electrolyzer 14 and the water (H₂O) electrolyzer 16 during day-time operation and the shutdown of these two devices during the night and use of stored oxygen from the daytime operation of the water (H₂O) electrolyzer 16 for the continuing operation of the auto-thermal reformer 12 at night. FIG. 6H-3 shows the composite mode of operation (daytime and night time) and the mass balance of inputs and outputs of the system 10. This flexibility in the different modes of operationallows the next generation refinery/combined cycle power plant to meet changes in market demand for products, market prices for products, and cost of inputs, including the cost of electricity. According to this example embodiment, the auto-thermal reformer 12 can function as either a syngas plant (mixture of H₂ + CO), a HYCO plant (separate streams of H₂ and CO), or a combination plant producing all three products (H₂, CO, syngas) and providing flexible fuels switching capability for all three configurations and products on an hourly, daily, weekly, monthly, or annual rate, based upon product demand, market conditions, and cost of electricity. In the above embodiment of the system 10, during the daytime the plant runs as a HYCO Plant (separate streams of H₂ and CO). In the above embodiment, during the night time with the carbon dioxide (CO₂) electrolyzer 14 and the water (H₂O) electrolyzer 16 turned off (possibly due to high electricity costs and/or the unavailable use of nighttime renewable electricity, i.e., PV electricity), the plant runs as a combination plant (H₂/CO/Syngas) producing all three products. In the above embodiment, for the night-time operation of the system 10, the natural gas (methane) input into the auto-thermal reformer 12 has been increased (two times) with no CO₂ produced. Since no CO₂ is generated in this embodiment, there is no need to run the carbon dioxide (CO₂) electrolyzer 14. The water (H₂O) electrolyzer 16 of this embodiment has been intentionally oversized to produce “additional” oxygen for both the daytime operation of the auto-thermal reformer 12 and the production and storage of oxygen for the nighttime operation of the auto-thermal reformer 12. The system 10 of this embodiment also uses renewable electricity. Operational production costs could be reduced using electricity off the grid at standard industrial rates for electricity.

FIG. 6I-1 depicts the easy and readily scalability of the system 10 with a 200X increase in the size of the devices and inputs/outputs of the embodiment shown in FIG. 6. This depiction incorporates the size of known auto-thermal reformers as a “single train” refinery producing approximately 700,000 kg-H2 per day (300 production days per year). This easy and readily scaling of the next generation refinery/power plant provides for a significant cost reduction in the capital expenses for expansion of the plant. The system 10 according to this embodiment can provide 80% conversion efficiency for the auto-thermal reformer 12, 70% conversion efficiency for the water (H₂O) electrolyzer 16, and 90% capture and collection efficiency for the CO₂ emitted from the auto-thermal reformer 12. The system 10 can provide 5 kWhrs per kg-CO produced vs. 8 kWhrs per kg-CO produced in the system FIG. 6. There is potential to realize up to 50% reduction in capital costs of equipment/devices at this scale. The system 10 according to this embodiment could achieve a greater than 75% reduction in CO₂ emissions by using the above combined cycle for the generation of H₂ for commercial FCEVs versus the use of diesel fuel for ICE Class 8 vehicles: <30 ton of CO₂ for a FCEV vs 120 ton of CO₂ for a ICE vehicle.

FIG. 6I-2 depicts the easy and readily scalability of the system 10 with a 200X increase in the size of the devices and inputs/outputs shown in FIG. 6. This depiction incorporates the size of known auto-thermal reformers that are currently in use as a “single train” refinery producing approximately 700,000 kg-H₂ per day (300 production days per year). This easy and readily scaling of the next generation refinery/power plant provides for a significant cost reduction in the capital expenses for expansion of the plant. The system 10 according to this embodiment can provide 80% conversion efficiency for the auto-thermal reformer 12, 70% conversion efficiency for the water (H₂O) electrolyzer 16, and 90% capture and collection efficiency for the CO₂ emitted from the auto-thermal reformer 12. The system 10 can provide 5 kWhrs per kg-CO produced vs. 8 kWhrs per kg-CO produced in the system FIG. 6. There is potential to realize up to 50% reduction in capital costs of equipment/devices at this scale. The system 10 according to this embodiment could achieve a greater than 75% reduction in CO₂ emissions by using the above combined cycle for the generation of H₂ for commercial FCEVs versus the use of diesel fuel for ICE Class 8 vehicles: <30 ton of CO₂ for a FCEV vs 120 ton of CO₂ for a ICE vehicle.

FIG. 6I-3 shows fuels switching and device switching capability of the system 10 and the different modes of operation according to an example embodiment. This flexibility in the different modes of operation allows the next generation refinery/combined cycle power plant to meet changes in market demand for products, market prices for products, and cost of inputs, including the cost of electricity. For example, when the carbon dioxide (CO₂) electrolyzer 14 is turned off (possibly due to high electricity costs), the auto-thermal reformer 12 can function as either a syngas plant (mixture of H₂ + CO), a HYCO plant (separate streams of H₂ and CO) or a combination (H₂/CO/syngas) producing all three products. In the above embodiment, the natural gas (methane) input has been increased (two times) which results in the plant performing as a syngas plant. Since no CO₂ is generated in this embodiment, there is no need to run the carbon dioxide (CO₂) electrolyzer 14. The water (H₂O) electrolyzer 16 has been intentionally oversized to produce additional hydrogen for fuel cell electric vehicles (FCEVs). The system 10 according to this embodiment also uses renewable electricity. Operational production costs could be reduced using electricity off the grid at standard industrial rates for electricity.

FIG. 6I-4 shows additional fuels switching and device switching capability of the system 10 according to example embodiments. This flexibility in the different modes of operation allows the next generation refinery/combined cycle power plant to meet changes in market demand for products, market prices for products, and cost of inputs, including the cost of electricity. For example, when the carbon dioxide (CO₂) electrolyzer 14 is turned off, possibly due to high electricity costs, the auto-thermal reformer 12 can function as either a syngas plant (mixture of H₂ + CO), a HYCO plant (separate streams of H₂ and CO) or a combination (H₂/CO/syngas) producing all three products and providing flexible fuels switching capability for all three configurations and products on an hourly, daily, weekly, monthly, or annual rate, based upon product demand, market conditions and cost of electricity. In the above embodiment, the plant runs as a combination plant (H₂/CO/syngas) producing all three products and providing flexible fuels switching capability for all three configurations and products on an hourly, daily, weekly, monthly, or annual rate, based upon product demand, market conditions and cost of electricity. Also in the above embodiment, the natural gas (methane) input into the auto-thermal reformer 12 has been increased (two times) with no CO₂ produced. Since no CO₂ is generated in this embodiment, there is no need to run the carbon dioxide (CO₂) electrolyzer 14. The water (H₂O) electrolyzer 16 has been intentionally oversized to produce additional hydrogen for fuel cell electric vehicles (FCEVs). Also in this embodiment of the system 10 uses renewable electricity. Operational production costs could be reduced using electricity off the grid at standard industrial rates for electricity.

FIG. 6J-1 illustrates the easy and readily scalability of the system 10 with a 2000X increase in the size of the devices and inputs/outputs of FIG. 6. This easy and readily scaling of the next generation refinery/power plant can provide for a significant cost reduction in the capital expenses for expansion of a “plant”. The auto-thermal reformer 12 can achieve 80% conversion efficiency, and the water (H₂O) electrolyzer 16 can achieve 70% conversion efficiency. The system 10 can achieve 90% efficiency for the capture and collection of CO₂ emitted from the auto-thermal reformer 12. The system 10 of FIG. 6I-1 can consume 5 kWhrs per kg-CO produced by the carbon dioxide (CO₂) electrolyzer 14, which can be compared to the 8 kWhrs consumed per kg-CO produced by the carbon dioxide (CO2) electrolyzer 14 in system 10 of FIG. 6. The system 10 may be able to achieve a reduction of up to 50% in capital costs of equipment/devices at this scale.

The system 10 of FIG. 6J-1 can be built out of energy HUBS, wherein ten single trains are required to form a HUB. This easy and readily scaling of the next generation refinery/power plant provides for a significant cost reduction in the capital expenses for expansion of the “plant”. The system 10 according to this embodiment can achieve 80% conversion efficiency for the auto-thermal reformer 12, 70% conversion efficiency for the water (H₂O) electrolyzer 16, and 90% capture and collection efficiency for the auto-thermal reformer 12. For example, the system 10 can start to move point sources of CO₂ emissions from 4.05 million Class 8 Diesel Trucks to 10 (50,000 MW each) of the next generation refineries/power plants according to the invention for CO₂ conversion to eSYNGAS and/or carbon capture utilization and storage (CCUS). The system 10 can achieve a 4 x 10⁶/10 or 400,000 fold reduction in point sources, reduction/elimination of other pollutants, i.e., NOX, particulates, etc. Each regional production HUB would also require 25,000MW of grid electricity generation capacity; which could be satisfied by 6-2000MW natural gas generators and 13,000MW of renewable energy (RE). CO₂ emissions from the 6-2000MW natural gas generators could be captured and collected for CCUS by the local utility. This would result in an additional 10 point sources of CO₂ emissions for a total of 20 CO₂ point sources, including 10 that capture and recycle the CO₂ (ATR H₂ generator and CO₂ electrolysis) and 10 utility point sources for the natural gas electricity generators. This represents a total reduction in CO₂ emissions point sources from the 4.05 million from Class 8 Diesel Trucks to 20 CO₂ emission sources from the next generation/combined cycle H₂ production and eSYNFUELs/eCHEMICALS production HUBs. For example, the system 10 could achieve a >75% reduction in CO₂ emissions by using the above combined cycle for the generation of H₂ for commercial FCEVs versus the use of diesel fuel for ICE Class 8 vehicles: <30 ton of CO₂ for a FCEV versus 120 ton of CO₂ for a ICE vehicle.

FIG. 6J-2 illustrates the system 10 according to an example embodiment which is at a commercial scale for a combination plant producing H₂, CO, and syngas and providing flexible fuels switching capability for all three configurations and products on an hourly, daily, weekly, monthly, or annual rate, based upon product demand, market conditions and cost of electricity.

According to this embodiment, the auto-thermal reformer 12 can achieve 80% conversion efficiency, and the water (H₂O) electrolyzer 16 can achieve 70% conversion efficiency. The system 10 can achieve 90% efficiency for the capture and collection of CO₂ emitted from the auto-thermal reformer 12. The system 10 can move point sources of CO₂ emissions from 4.05 million Class 8 Diesel Trucks to 10 (50,000 MW each) Next Generation Refineries/Power Plants which include the system 10 of the present invention for CO₂ conversion to eSYNGAS and/or carbon capture utilization and storage (CCUS). The system 10 can achieve a 4 x 10⁶/10, or, a 400,000 fold reduction in point sources, and a reduction or elimination in other pollutants, i.e., NOX, particulates, etc.

It is noted that if each regional production hub requires 25,000MW of grid electricity generation capacity, this requirement could be satisfied by 6 - 2000MW natural gas generators and 13,000MW of renewable energy. The CO₂ emissions from the 6-2000MW natural gas generators could be captured and collected for CCUS by a local utility. This would result in an additional 10 point sources of CO₂ emissions for a total of 20 CO₂ point sources. There would be 10 point sources that capture and recycle the CO₂ (ATR H₂ generator + CO₂ electrolysis) and 10 utility point sources for the natural gas electricity generators. This represents a total reduction in CO₂ emissions point sources of from the 4.05 million from Class 8 Diesel Trucks to 20 CO₂ emission sources from the Next Generation/Combined Cycle H₂ Production according to the present invention and the eSYNFUELs/eCHEMICALS Production HUBs.

The system 10 of FIGS. 6J-2 and 6J-3 can be built out of energy HUBs, where 10 single trains form a HUB. The next generation refinery/combined cycle power plant is depicted on a commercial scale for a combination plant (H₂/CO/Syngas) producing all three products and providing flexible fuels switching capability for all three configurations and products on an hourly, daily, weekly, monthly, or annual rate, based upon product demand, market conditions and cost of electricity. The system 10 can provide 80% conversion efficiency for the auto-thermal reformer 12, 70% conversion efficiency for the water (H₂O) electrolyzer 16, and 90% capture and collection efficiency for CO₂ emitted from the auto-thermal reformer 12. The system 10 can start to move point sources of CO₂ emissions from 4.05 million Class 8 Diesel Trucks to 10 (50,000 MW each) next generation refineries/power plants for CO₂ conversion to eSYNGAS and/or CCUS. The system can also achieve a 4 x 10⁶/10 or 400,000 fold reduction in point sources, and reduction/elimination of other pollutants, i.e., NOX, particulates, etc. Each regional production HUB would also require 25,000MW of grid electricity generation capacity. This could be satisfied by 6-2000MW natural gas generators and 13,000MW of renewable energy. CO₂ emissions from the 6-2000MW natural gas generators could be captured and collected for CCUS by the local utility. This would result in an additional 10 point sources of CO₂ emissions for a total of 20 CO₂ point sources, including 10 that capture and recycle the CO₂ (ATR H₂ generator + CO₂ electrolysis) and 10 utility point sources for the natural gas electricity generators. This represents a total reduction in CO₂ emissions point sources of from the 4.05 million from Class 8 Diesel Trucks to 20 CO₂ emission sources from the next generation/combined cycle H₂ production and eSYNFUELs/eCHEMICALS production HUBs. The system 10 of FIG. 6J-2 could also achieve a >75% reduction in CO₂ emissions by using the above combined cycle for the generation of H₂ for commercial FCEVs versus the use of diesel fuel for ICE Class 8 vehicles: <30 ton of CO₂ for a FCEV versus 120 ton of CO₂ for a ICE vehicle.

FIG. 6K-1 illustrates an embodiment of the system 10 which is capable of producing enough hydrogen to fuel the current commercial transport sector in the United States. This would include 20 x 10⁹ kg-H₂ from H₂O electrolysis using the water (H₂O) electrolyzer 16 and 6.5 x 10⁹ kg-H₂ from methane using the auto-thermal reformer 12. FIG. 6K-1 also depicts the production of 139.3 x 10⁹ kg eSYNGAS, including 12.3 x 10⁹ kg H₂ from the auto-thermal reforming of methane using the auto-thermal reformer 12 and 127 x 10⁹ kg CO from the electrolysis of carbon dioxide using the carbon dioxide (CO₂) electrolyzer 14 and with the CO₂ from the auto-thermal reformer 12.

This eSYNGAS could be used for the production of eFUELS and/or eCHEMICALS depicted in FIG. 6E. According to this embodiment, the auto-thermal reformer 12 can achieve 80% conversion efficiency, and the water (H₂O) electrolyzer 16 can achieve 70% conversion efficiency. The system 10 can achieve 90% efficiency for the capture and collection of CO₂ emitted from the auto-thermal reformer 12. The system 10 can move point sources of CO₂ emissions from 4.05 million Class 8 Diesel Trucks to 10 (50,000 MW each) Next Generation Refineries/Power Plants which include the system 10 of the present invention for CO₂ conversion to eSYNGAS and/or carbon capture utilization and storage (CCUS). The system 10 can achieve a 4 x 10⁶/10, or, a 400,000 fold reduction in point sources, and a reduction or elimination in other pollutants, i.e., NOX, particulates, etc. It is noted that 75 x 2000MW natural gas generators could be used to generate 1.0 x 10¹² KWHrs of electricity, at 50% natural gas generation and 50% renewable energy generation. This could include a total of ten 25000MW ATR hydrogen generators and ten 7.5 x 2000MW natural gas electricity generators. This would give a total of 85 units; or one 25000MW ATR generator and 7.5 x 2000MW electricity generators per regional hub.

FIG. 6K-2 illustrates the same embodiment of the system 10 shown in FIG. 6K-1, except for the energy units are shown in Quads.

FIGS. 6L-1 and 6L-2 illustrate another embodiment depicting equipment and requirements to produce enough hydrogen to fuel the current transport sector in the U.S. The amount of hydrogen produced includes 60 x 10⁹ kg H₂ from electrolysis by the water (H₂O) electrolyzer 16 and 19.5 x 10⁹ kg of H₂ from the auto-thermal reforming of methane by the auto-thermal reformer 12. FIGS. 6L-1 and 6L-2 also illustrate the production of 418 x 10⁹ kg eSYNGAS (37 x 10⁹ kg H₂) from the auto-thermal reforming of methane by the auto-thermal reformer 12 and the production of 381 x 10⁹ kg CO from electrolysis of CO₂ by the CO₂ electrolyzer 14. This eSYNGAS could be used for the production of the eFUELS and/or eCHEMICALS depicted in FIG. 6E.

According to this embodiment, the auto-thermal reformer 12 can achieve 80% conversion efficiency, and the water (H₂O) electrolyzer 16 can achieve 70% conversion efficiency. The system 10 can achieve 90% efficiency for the capture and collection of CO₂ emitted from the auto-thermal reformer 12. This embodiment is able to provide approximately 6.5 Quad of H₂ for passenger vehicles and 3.2 Quad of H₂ for commercial transport vehicles, 5.7 Quad of hydrogen, and 381 x 10⁹ kg CO for the production of the eFUELS and/or eCHEMICALS depicted in FIG. 6E.

FIG. 6L-2 shows the same embodiment as FIG. 6L-1, except with the energy units in Quads. More specifically, FIG. 6L-2 illustrates the equipment and input requirements for the production of hydrogen needed to fuel the current transportation sector in the U.S. This includes 6.87 Quad of H₂ from H₂O electrolysis by the water (H₂O) electrolyzer 16 and 2.7 Quad of H₂ from the auto-thermal reforming (ATR) of methane by the auto-thermal reformer 12. This embodiment also includes the production of 418 x 10⁹ kg eSYNGAS, including 5.7 Quad of H₂ from the auto-thermal reforming of methane by the auto-thermal reformer 12 and 381 x 10⁹ kg CO from electrolysis of CO₂ by the carbon dioxide (CO₂) electrolyzer 14, wherein the CO₂ is obtained from the auto-thermal reformer 12. This eSYNGAS could be used for the production of the eFUELS and/or eCHEMICALS depicted in FIG. 6E. This embodiment is able to provide approximately 6.5 Quad of H₂ for passenger vehicles, 3.2 Quad of H₂ for commercial transport vehicles, 5.7 Quad of Hydrogen, and 381 x 10⁹ kg CO for the production of eFUELS and/or eCHEMICALS depicted in FIG. 6E.

FIGS. 6M-1 and 6M-2 show an embodiment of the system in an ideal state. FIG. 6M-1 shows the energy units in kilowatt-hours (kWh), and FIG. 6M-2 shows the energy units in Quads. The system 10 is shown to scale and is able to produce 12.9 Quad of hydrogen, including e-syngas for the transportation sector. The system 10 is flexible and scalable, and thus can operate in multiple modes across the different regions of the U.S. In states or regions with abundant and low-cost renewable energy, the “operational” mode of the system 10 would favor the use of CO₂ electrolysis by the carbon dioxide (CO₂) electrolyzer 14 of the CO₂ generated by the auto-thermal reformer 12. In states or regions with limited and higher cost renewable energy, the “operational” mode of the system 10 would favor the limited use of CO₂ electrolysis by the carbon dioxide (CO₂) electrolyzer 14 of the CO₂ generated by the auto-thermal reformer 12 and alternatively use “additional” methane feedstock in the auto-thermal reformer 12 which would thereby reduce/eliminate the generation of CO₂ by the auto-thermal reformer 12 with the bulk/all of oxygen supplied by the water (H₂O) electrolyzer 16. Other factors and conditions that could effect the “operational” mode of operation of the system 10 could include, but are not limited to market demand for products, market prices for products, and cost of inputs, including the cost of electricity.

According to this embodiment, the auto-thermal reformer 12 can achieve 80% conversion efficiency, and the water (H₂O) electrolyzer 16 can achieve 70% conversion efficiency. The system 10 can achieve 90% efficiency for the capture and collection of CO₂ emitted from the auto-thermal reformer 12.

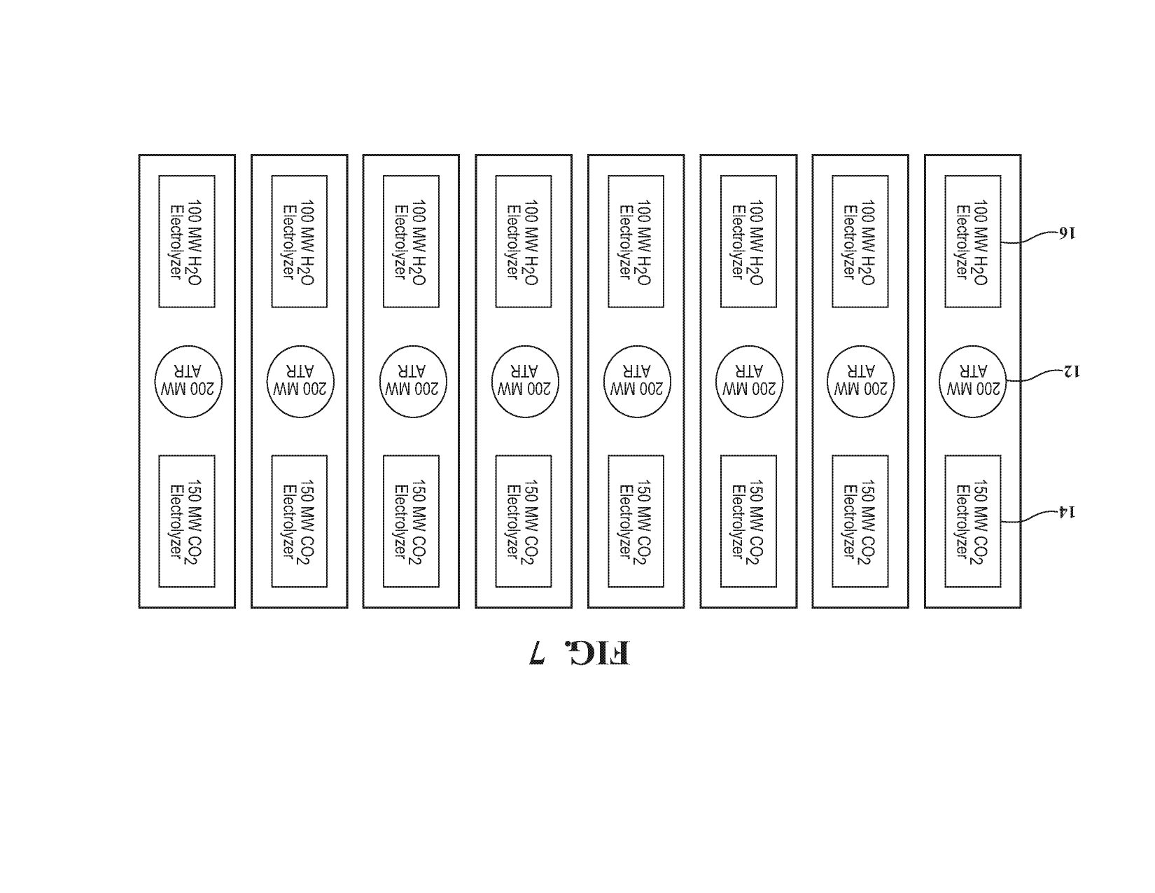

FIG. 7 illustrates the design and use of modules, wherein each module includes the auto-thermal reformer 12, the carbon dioxide (CO₂) electrolyzer 14, and the water (H₂O) electrolyzer 16, according to an example embodiment. More specifically, each module is comprised of a XMW H₂O Electrolyzer 16, YMW Auto-Thermal Reformer 12, and ZMW CO₂ Electrolyzer 14. In the embodiment of FIG. 7, X = 100, Y = 200, and Z = 150. Accordingly, each module is comprised of a 100MW H₂O Electrolyzer, 200MW Auto-Thermal Reformer, and 150MW CO₂ Electrolyzer to create a 450 MW module. The design and use of modules allows for the easy scaling and expansion of the invention to create trains and hubs. For example, FIG. 7 shows eight (8) modules with each module comprised of a 100MW H₂O electrolyzer 16, 200MW auto-thermal reformer 12, and 150MW CO₂ electrolyzer 14 combined to create a train with a cumulative capacity of: 800MW from H₂O electrolysis, 1600MW from Auto-Thermal Reforming, and 1200MW CO₂ Electrolysis, which totals 3600 MW.

In summary, the system 10 can be configured as a “turn-key” onsite single train energy power plant, much like a current refinery. More specifically, the auto-thermal reformer 12, the carbon dioxide (CO₂) electrolyzer 14, and the water (H₂O) electrolyzer 16, as shown in FIG. 1, can be placed in sufficiently close proximity to each other and in sufficiently close proximity to the Fischer-Tropsch process equipment. The rejected/waste heat from the Fischer-Tropsch process equipment using the syngas produced by the auto-thermal reformer 12 and the carbon dioxide (CO₂) electrolyzer 14 in the system 10 could be used to improve the efficiencies of the carbon dioxide (CO₂) electrolyzer 14 and/or water (H₂O) electrolyzer 16 in the system 10, thereby improving the efficiencies of the electrolyzers 14, 16 and reducing the quantity of electricity required as inputs to the electrolyzers 14, 16.

Obviously, many modifications and variations of the present invention are possible in light of the above teachings and may be practiced otherwise than as specifically described while within the scope of the following claims.

What is claimed is:

1. A system for producing hydrogen (H₂), comprising:
an auto-thermal reformer for receiving electrolytic oxygen (O₂), a hydrocarbon fuel source, and water (H₂O), and performing a partial oxidation reaction to produce auto-thermal reformed hydrogen (H₂) and carbon dioxide (CO₂); and
a carbon dioxide (CO₂) electrolyzer for receiving electricity and the carbon dioxide (CO₂) from the auto-thermal reformer, performing electrolysis on the carbon dioxide (CO₂), and producing electrolytic carbon monoxide (CO) and a first portion of the electrolytic oxygen (O₂) received by the auto-thermal reformer.

2. The system of claim 1, wherein methane (CH₄) is the hydrocarbon fuel source received by the auto-thermal reformer.

3. The system of claim 1, wherein the following reactions occur in the auto-thermal reformer: CH₄ + ½O₂ → CO + 2H₂ (+ heat) and CO + H₂O → CO₂ + H₂ (+ heat).

4. The system of claim 1 further including a water (H₂O) electrolyzer for receiving electricity and water, performing electrolysis on the water, producing electrolytic hydrogen (H₂), and producing a second portion of the electrolytic oxygen (O₂) received by the auto-thermal reformer.

5. The system of claim 4, wherein a hydrogen evolution reaction (HER) and an oxygen evolution reaction (OER) occur in the water (H₂O) electrolyzer.

6. The system of claim 4, wherein the water (H₂O) electrolyzer includes an anode and a cathode separated by an electrolyte.

7. The system of claim 6, wherein the electrolyte includes a polymer electrolyte membrane (PEM), the following reaction occurs at the anode: 2H₂O → O₂ + 4H⁺ + 4e⁻ and the following reaction occurs at the cathode: 4H⁺ + 4e⁻ → 2H₂.

8. The system of claim 6, wherein the electrolyte includes a liquid alkaline solution of sodium or potassium hydroxide or the electrolyte includes a solid alkaline exchange membrane (AEM).

9. The system of claim 6, wherein the electrolyte includes a solid ceramic material.

10. A method of manufacturing hydrogen (H₂), comprising the steps of:
providing electrolytic oxygen (O₂), a hydrocarbon fuel source, and water (H₂O) to an auto-thermal reformer to initiate a partial oxidation reaction in the auto-thermal reformer, wherein the partial oxidation reaction produces auto-thermal reformed hydrogen (H₂) and carbon dioxide (CO₂); and
providing electricity and the carbon dioxide (CO₂) from the auto-thermal reformer to a carbon dioxide (CO₂) electrolyzer to initiate electrolysis on the carbon dioxide (CO₂) in the carbon dioxide (CO₂) electrolyzer, wherein the electrolysis produces electrolytic carbon monoxide (CO) and a first portion of the electrolytic oxygen (O₂) provided to the auto-thermal reformer.

11. The method of claim 10, wherein methane is the hydrocarbon fuel source provided to the auto-thermal reformer.

12. The method of claim 10, wherein the following reactions occur in the auto-thermal reformer: CH₄ + ½O₂ → CO + 2H₂ (+ heat) and CO + H₂O → CO₂ + H₂ (+ heat).

13. The method of claim 10 including providing electricity and water to a water (H₂O) electrolyzer, wherein the water (H₂O) electrolyzer performs electrolysis on the water and produces electrolytic hydrogen (H₂) and a second portion of the electrolytic oxygen (O₂) provided to the auto-thermal reformer.

14. The method of claim 13, wherein a hydrogen evolution reaction (HER) and an oxygen evolution reaction (OER) occur in the water (H₂O) electrolyzer.

15. The method of claim 13, wherein the water (H₂O) electrolyzer includes an anode and a cathode separated by an electrolyte.

16. The method of claim 15, wherein the electrolyte includes a polymer electrolyte membrane (PEM), the following reaction occurs at the anode: 2H₂O → O₂ + 4H⁺ + 4e⁻ and the following reaction occurs at the cathode: 4H⁺ + 4e⁻ → 2H₂.

17. The method of claim 15, wherein the electrolyte includes a liquid alkaline solution of sodium or potassium hydroxide or the electrolyte includes a solid alkaline exchange membrane (AEM).

18. The method of claim 15, wherein the electrolyte includes a solid ceramic material.

19. The method of claim 10 including combining the carbon monoxide (CO) produced by the carbon dioxide (CO₂) electrolyzer with the hydrogen produced by the auto-thermal reformer to form syngas.

20. The method of claim 19 including producing synthetic natural gas, ammonia, methanol, a hydrocarbon fuel, or ammonia from the syngas by a Fischer-Tropsch process.
